(19) United States
(12) Patent Application Publication
(10) Pub. No.: US 2023/0269662 A1
(43) Pub. Date: Aug. 24, 2023

(54) ORTHOGONAL DMRS MAPPING METHOD FOR MT AND DU, AND NODE USING METHOD

(71) Applicant: LG Electronics Inc., Seoul (KR)

(72) Inventors: Hyangsun YOU, Seoul (KR); Hyunsoo KO, Seoul (KR); Jaenam SHIM, Seoul (KR)

(21) Appl. No.: 18/015,217

(22) PCT Filed: Jul. 9, 2021
(86) PCT No.: PCT/KR2021/008819

§ 371 Date: Jan. 9, 2023

Related U.S. Application Data
(60) Provisional application No. 63/063,192, filed on Aug. 7, 2020.

(30) Foreign Application Priority Data
Jul. 9, 2020 (KR) 10-2020-0084596

(51) Int. Cl. H04W 48/20; H04W 48/12

(52) U.S. Cl. CPC H04W 48/20; H04W 48/12

(57) ABSTRACT

The present specification provides a method by which an integrated access and backhaul (IAB) node performs a mobile terminal (MT) operation and a distributed unit (DU) operation in a wireless communication system, the method performing initial access operations with a parent node and a child node, respectively, an MT operation with the parent node, and a DU operation with the child node, wherein a first demodulation reference signal (DMRS) is applied to the MT operation, a second DMRS is applied to the DU operation, and DMRS ports belonging to different code division multiplexing (CDM) groups are applied to the first DMRS and the second DMRS, respectively.

### BACKGROUND OF THE DISCLOSURE

### Field of the Disclosure

The present specification relates to wireless communication.

### Related Art

As a wider range of communication devices require larger communication capacities, the need for mobile broadband communication that is more enhanced than the existing Radio Access Technology (RAT) is rising. Additionally, massive Machine Type Communications (massive MCT), which connects multiple devices and objects so as to provide various services regardless of time and place, is also one of the most important issues that are to be considered in the next generation communication. Moreover, discussions are made on services/terminals (or user equipment (UE)) that are sensitive to reliability and latency. And, discussions are made on the adoption of a next generation radio access technology that is based on the enhanced mobile broadband communication, massive MTC, Ultra-Reliable and Low Latency Communication (URLLC), and so on. And, for convenience, the corresponding technology will be referred to as a new radio access technology (new RAT or NR).

On the other hand, integrated access and backhaul link may be provided. Hereinafter, in this specification, features for Integrated Access Backhaul (IAB) will be provided.

### SUMMARY OF THE DISCLOSURE

According to one embodiment of the present specification, a method performing the parent node and MT operation and perform the child node and DU operation, where a first demodulation reference signal (DMRS) is applied to the MT operation, where a second DMRS is applied to the DU operation, and where DMRS ports belonging to different code division multiplexing (CDM) groups are applied to each of the first DMRS and the second DMRS, may be provided.

According to the present specification, for example, when an MT receives a PDSCH through a parent link and a DU receives a PUSCH through a child link, the DMRS of two PDSCHs and the DMRS of the PUSCH can be transmitted orthogonally, accordingly, the MT and the DU can accurately perform channel estimation for PDSCH reception and channel estimation for PUSCH reception, respectively.

The effects that can be obtained through a specific example of the present specification are not limited to the effects listed above. For example, there may be various technical effects that a person having ordinary skill in the related art can understand or derive from the present specification. Accordingly, specific effects of the present specification are not limited to those explicitly described in the present specification, and may include various effects that can be understood or derived from the technical features of the present specification.

### BRIEF DESCRIPTION OF THE DRAWINGS

FIG. 1 illustrates a system structure of a new generation radio access network (NG-RAN) to which NR is applied.

FIG. 2 illustrates functional partitioning between NG-RAN and 5GC.

FIG. 3 illustrates a frame structure applicable in NR.

FIG. 4 illustrates an example of a frame structure for the new radio access technology (new RAT).

FIG. 5 shows examples of 5G usage scenarios to which the technical features of the present specification can be applied.

FIG. 6 schematically illustrates an example of integrated access and backhaul links.

FIG. 7 schematically illustrates an example of a link between a DgNB, an RN, and a UE.

FIG. 8 schematically shows an example of a backhaul link and an access link.

FIG. 9 schematically shows an example of a parent link and a child link.

FIG. 10 schematically shows an example of timing alignment case 1.

FIG. 11 schematically shows an example of timing alignment case 6.

FIG. 12 schematically shows an example of a timing alignment case 7.

FIGS. 13 and 14 schematically illustrate an example of resource multiplexing among MTs and DUs.

FIG. 15 schematically illustrates an example of an additional DMRS.

FIG. 16 is a flowchart of a method of performing an MT operation and a DU operation according to an embodiment of the present specification.

FIG. 17 illustrates an example of PDSCH DMRS configure type 1, and FIG. 18 illustrates an example of PDSCH DMRS configure type 2.

FIG. 19 is a flowchart of a method of performing an MT operation and a DU operation according to another embodiment of the present specification.

FIG. 20 is a flowchart of a method of performing an MT operation and a DU operation (from the perspective of an IAB node) according to an embodiment of the present specification.

FIG. 21 is a block diagram of an example of a device performing an MT operation and a DU operation (from the perspective of an IAB node) according to an embodiment of the present specification.

FIG. 22 is a flowchart of a method of transmitting configure information (from a node point of view) according to an embodiment of the present specification.

FIG. 23 is a block diagram of an example of a device for transmitting configure information (from a node point of view) according to an embodiment of the present specification.

FIG. 24 schematically illustrates an example of MTs and DUs in an IAB node.

FIG. 25 schematically illustrates an example for scenario 1.

FIG. 26 schematically illustrates an example for scenario 2.

FIG. 27 schematically illustrates an example for scenario 3.

FIG. 28 shows an example of a method of operating an IAB node.

FIGS. 29 and 30 show an example of a case where the MT and DU of the IAB-node simultaneously perform UL Tx operations and DL Tx operations, respectively.

FIG. 31 illustrates a method of operation of a device according to the present specification.

FIG. 32 is an application example of Method 1.

FIG. 33 schematically illustrates an example of an OFDM symbol group.

FIG. 34 shows an exemplary communication system (1), according to an embodiment of the present specification.

FIG. 35 shows an exemplary wireless device to which the present specification can be applied.

FIG. 36 shows another example of a wireless device applicable to the present specification.

FIG. 37 shows a signal process circuit for a transmission signal according to an embodiment of the present specification.

FIG. 38 shows another example of a wireless device according to an embodiment of the present specification.

FIG. 39 shows a hand-held device to which the present specification is applied.

FIG. 40 shows a vehicle or an autonomous vehicle to which the present specification is applied.

### DESCRIPTION OF EXEMPLARY EMBODIMENTS

In the present specification, “A or B” may mean “only A”, “only B” or “both A and B”. In other words, in the present specification, “A or B” may be interpreted as “A and/or B”. For example, in this specification, “A, B or C” refers to “only A”, “only B”, “only C”, or “any combination of A, B and C”.

A forward slash (/) or comma used herein may mean “and/or”. For example, “A/B” may mean “A and/or B”. Accordingly, “A/B” may mean “only A”, “only B”, or “both A and B”. For example, “A, B, C” may mean “A, B, or C”.

In the present specification, “at least one of A and B” may mean “only A”, “only B”, or “both A and B”. In addition, in the present specification, the expression “at least one of A or B” or “at least one of A and/or B” can be interpreted the same as “at least one of A and B”.

In addition, in the present specification, “at least one of A, B and C” means “only A”, “only B”, “only C”, or “any combination of A, B and C”. In addition, “at least one of A, B or C” or “at least one of A, B and/or C” can mean “at least one of A, B and C”.

In addition, parentheses used in the present specification may mean “for example”. Specifically, when described as “control information (PDCCH)”, “PDCCH” may be proposed as an example of “control information”. In other words, “control information” of the present specification is not limited to “PDCCH”, and “PDCCH” may be suggested as an example of “control information”. In addition, even when described as “control information (i.e., PDCCH)”, “PDCCH” may be proposed as an example of “control information”.

In the present specification, technical features that are individually described in one drawing may be implemented individually or at the same time.

Hereinafter, a new radio access technology (new RAT, NR) will be described.

As a wider range of communication devices require larger communication capacities, the need for mobile broadband communication that is more enhanced than the existing Radio Access Technology (RAT) is rising. Additionally, massive Machine Type Communications (massive MCT), which connects multiple devices and objects so as to provide various services regardless of time and place, is also one of the most important issues that are to be considered in the next generation communication. Moreover, discussions are made on services/terminals (or user equipment (UE)) that are sensitive to reliability and latency. And, discussions are made on the adoption of a next generation radio access technology that is based on the enhanced mobile broadband communication, massive MTC, Ultra-Reliable and Low Latency Communication (URLLC), and so on. And, for convenience, the corresponding technology will be referred to as a new RAT or NR.

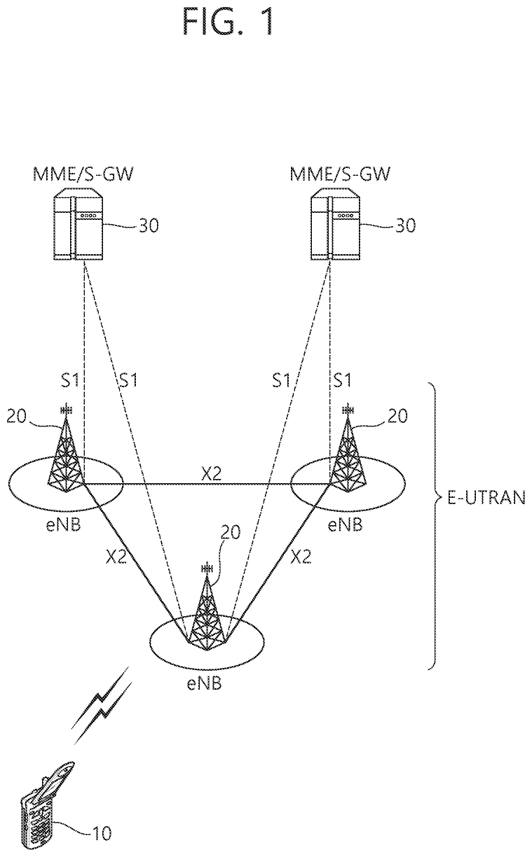

FIG. 1 illustrates a system structure of a new generation radio access network (NG-RAN) to which NR is applied.

Referring to FIG. 1, the NG-RAN may include a gNB and/or an eNB providing a user plane and a control plane protocol termination to a terminal. FIG. 1 illustrates a case of including only the gNB. The gNB and eNB are connected to each other by an Xn interface. The gNB and eNB are connected to a 5G Core Network (5GC) through an NG interface. More specifically, the gNB and eNB are connected to the access and mobility management function (AMF) through an NG-C interface and connected to a user plane function (UPF) through an NG-U interface.

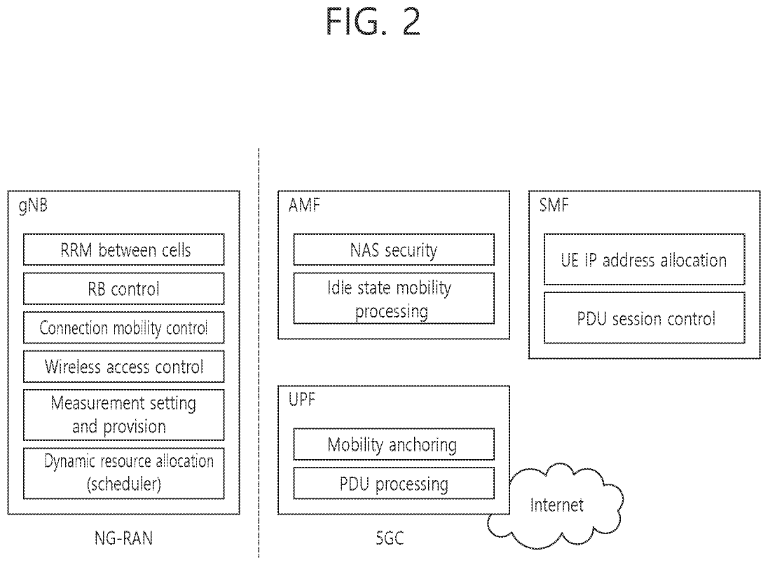

FIG. 2 illustrates functional partitioning between NG-RAN and 5GC.

Referring to FIG. 2, the gNB may provide inter-cell radio resource management (RRM), radio bearer (RB) control, connection mobility control, radio access control, measurement configuration & provision, dynamic resource allocation, and the like. An AMF may provide functions such as NAS security, idle state mobility handling, and the like. A UPF may provide functions such as mobility anchoring, PDU handling, and the like. A session management function (SMF) may provide functions such as UE IP address allocation, PDU session control, and the like.

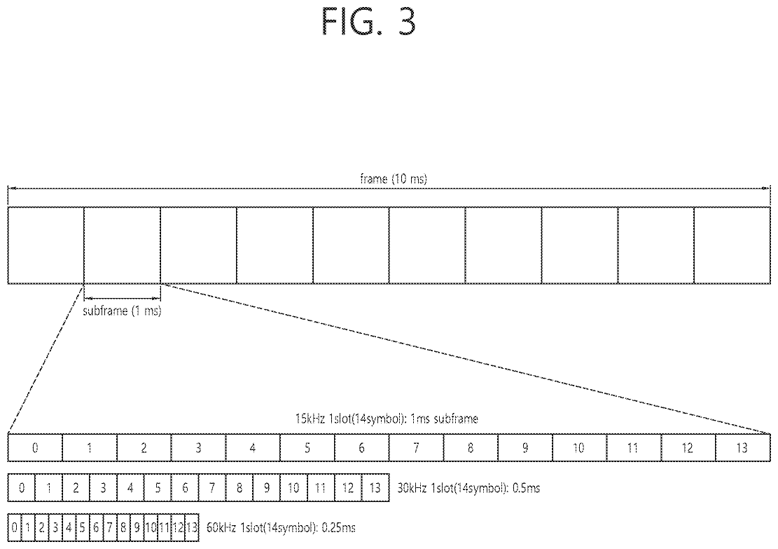

FIG. 3 illustrates a frame structure applicable in NR.

Referring to FIG. 3, a frame may consist of 10 milliseconds (ms) and may include 10 subframes of 1 ms.

A subframe may include one or a plurality of slots according to subcarrier spacing.

TABLE 1

| | Δf = 2^{μ} · | |
|---|---|---|
| μ | 15 [kHz] | CP(Cyclic Prefix) |
| 0 | 15 | Normal |
| 1 | 30 | Normal |
| 2 | 60 | Normal, Extended |
| 3 | 120 | Normal |
| 4 | 240 | Normal |

Table 2 below shows the number of slots in a frame (N^{frameμ}ₛₗₒₜ), the number of slots in a subframe (N^{subframeμ}ₛₗₒₜ), and the number of symbols in a slot (N^{slot}_{symb}) according to the subcarrier spacing configuration μ.

TABLE 2

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

FIG. 3 shows μ=0, 1, and 2.

A physical downlink control channel (PDCCH) may include one or more control channel elements (CCEs) as shown in Table 3 below.

TABLE 3

| Aggregation level | Number of CCEs |
|---|---|
| 1 | 1 |
| 2 | 2 |
| 4 | 4 |
| 8 | 8 |
| 16 | 16 |

In other words, the PDCCH may be transmitted through a resource including 1, 2, 4, 8 or 16 CCEs. Here, the CCE includes six resource element groups (REGs), and one REG includes one resource block in the frequency domain and one orthogonal frequency division multiplexing (OFDM) symbol in the time domain. The following technologies/characteristics may be applied to NR.

<Self-Contained Subframe Structure>

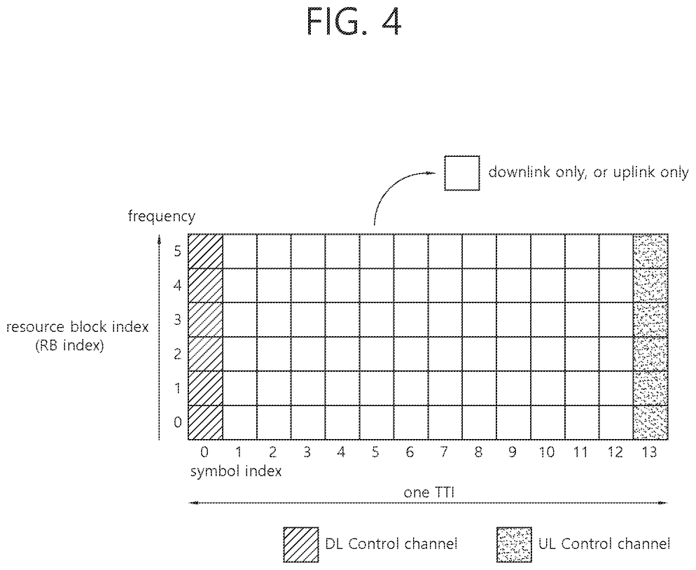

FIG. 4 illustrates an example of a frame structure for the new radio access technology (new RAT).

In NR, as a purpose for minimizing latency, as shown in FIG. 4, a structure having a control channel and a data channel being processed with Time Division Multiplexing (TDM), within one TTI, may be considered as one type of frame structure.

In FIG. 4, an area marked with slanted lines represents a downlink control area, and an area marked in black represents an uplink control area. An area marked in black may be used for downlink (DL) data transmission or may be used for uplink (UL) data transmission. The characteristic of such structure is that, since downlink (DL) transmission and uplink (UL) transmission are carried out sequentially, DL data is sent out (or transmitted) from a subframe, and UL Acknowledgement/Not-acknowledgement (ACK/NACK) may also be received in the subframe. As a result, time needed until data retransmission, when a data transmission error occurs, may be reduced, and, accordingly, latency in the final data transfer (or delivery) may be minimized.

In the above-described data and control TDMed subframe structure, a time gap is needed for a transition process (or shifting process) from a transmission mode to a reception mode of the base station and UE, or a transition process (or shifting process) from a reception mode to a transmission mode of the base station and UE. For this, in a self-contained subframe structure, some of the OFDM symbols of a time point where a transition from DL to UL occurs may be configured as a guard period (GP).

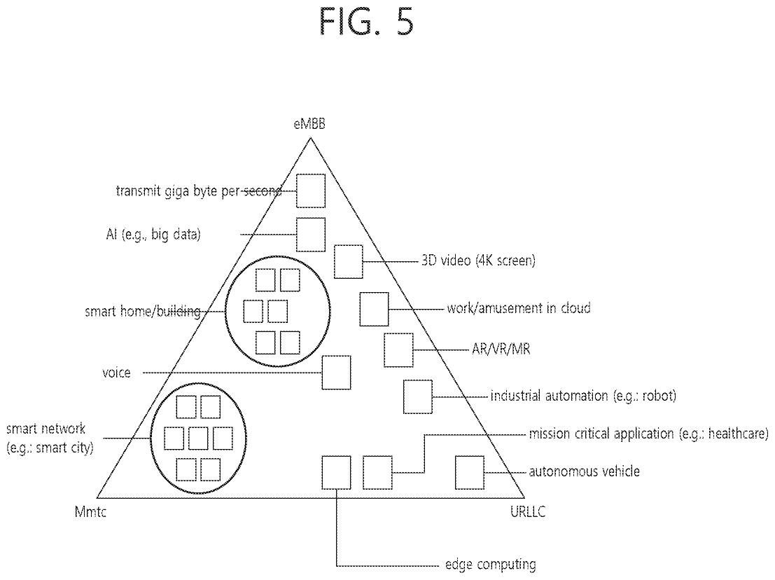

FIG. 5 shows examples of 5G usage scenarios to which the technical features of the present specification can be applied. The 5G usage scenarios shown in FIG. 5 are only exemplary, and the technical features of the present specification can be applied to other 5G usage scenarios which are not shown in FIG. 5.

Referring to FIG. 5, the three main requirements areas of 5G include (1) enhanced mobile broadband (eMBB) domain, (2) massive machine type communication (mMTC) area, and (3) ultra-reliable and low latency communications (URLLC) area. Some use cases may require multiple areas for optimization and, other use cases may only focus on only one key performance indicator (KPI). 5G is to support these various use cases in a flexible and reliable way.

eMBB focuses on across-the-board enhancements to the data rate, latency, user density, capacity and coverage of mobile broadband access. The eMBB aims ˜10 Gbps of throughput. eMBB far surpasses basic mobile Internet access and covers rich interactive work and media and entertainment applications in cloud and/or augmented reality. Data is one of the key drivers of 5G and may not be able to see dedicated voice services for the first time in the 5G era. In 5G, the voice is expected to be processed as an application simply using the data connection provided by the communication system. The main reason for the increased volume of traffic is an increase in the size of the content and an increase in the number of applications requiring high data rates. Streaming services (audio and video), interactive video and mobile Internet connectivity will become more common as more devices connect to the Internet. Many of these applications require always-on connectivity to push real-time information and notifications to the user. Cloud storage and applications are growing rapidly in mobile communication platforms, which can be applied to both work and entertainment. Cloud storage is a special use case that drives growth of uplink data rate. 5G is also used for remote tasks on the cloud and requires much lower end-to-end delay to maintain a good user experience when the tactile interface is used. In entertainment, for example, cloud games and video streaming are another key factor that increases the demand for mobile broadband capabilities. Entertainment is essential in smartphones and tablets anywhere, including high mobility environments such as trains, cars and airplanes. Another use case is augmented reality and information retrieval for entertainment. Here, augmented reality requires very low latency and instantaneous data amount.

mMTC is designed to enable communication between devices that are low-cost, massive in number and battery-driven, intended to support applications such as smart metering, logistics, and field and body sensors. mMTC aims ˜10 years on battery and/or ˜1 million devices/km². mMTC allows seamless integration of embedded sensors in all areas and is one of the most widely used 5G applications. Potentially by 2020, IoT devices are expected to reach 20.4 billion. Industrial IoT is one of the areas where 5G plays a key role in enabling smart cities, asset tracking, smart utilities, agriculture and security infrastructures.

URLLC will make it possible for devices and machines to communicate with ultra-reliability, very low latency and high availability, making it ideal for vehicular communication, industrial control, factory automation, remote surgery, smart grids and public safety applications. URLLC aims ˜1 ms of latency. URLLC includes new services that will change the industry through links with ultra-reliability/low latency, such as remote control of key infrastructure and self-driving vehicles. The level of reliability and latency is essential for smart grid control, industrial automation, robotics, drone control and coordination.

Next, a plurality of use cases included in the triangle of FIG. 5 will be described in more detail.

5G can complement fiber-to-the-home (FTTH) and cable-based broadband (or DOCSIS) as a means of delivering streams rated from hundreds of megabits per second to gigabits per second. This high speed can be required to deliver TVs with resolutions of 4K or more (6K, 8K and above) as well as virtual reality (VR) and augmented reality (AR). VR and AR applications include mostly immersive sporting events. Certain applications may require special network settings. For example, in the case of a VR game, a game company may need to integrate a core server with an edge network server of a network operator to minimize delay.

Automotive is expected to become an important new driver for 5G, with many use cases for mobile communications to vehicles. For example, entertainment for passengers demands high capacity and high mobile broadband at the same time. This is because future users will continue to expect high-quality connections regardless of their location and speed. Another use case in the automotive sector is an augmented reality dashboard. The driver can identify an object in the dark on top of what is being viewed through the front window through the augmented reality dashboard. The augmented reality dashboard displays information that will inform the driver about the object's distance and movement. In the future, the wireless module enables communication between vehicles, information exchange between the vehicle and the supporting infrastructure, and information exchange between the vehicle and other connected devices (e.g., devices accompanied by a pedestrian). The safety system allows the driver to guide the alternative course of action so that he can drive more safely, thereby reducing the risk of accidents. The next step will be a remotely controlled vehicle or self-driving vehicle. This requires a very reliable and very fast communication between different self-driving vehicles and between vehicles and infrastructure. In the future, a self-driving vehicle will perform all driving activities, and the driver will focus only on traffic that the vehicle itself cannot identify. The technical requirements of self-driving vehicles require ultra-low latency and high-speed reliability to increase traffic safety to a level not achievable by humans.

Smart cities and smart homes, which are referred to as smart societies, will be embedded in high density wireless sensor networks. The distributed network of intelligent sensors will identify conditions for cost and energy-efficient maintenance of a city or house. A similar setting can be performed for each home. Temperature sensors, windows and heating controllers, burglar alarms and appliances are all wirelessly connected. Many of these sensors typically require low data rate, low power and low cost. However, for example, real-time HD video may be required for certain types of devices for monitoring.

The consumption and distribution of energy, including heat or gas, is highly dispersed, requiring automated control of distributed sensor networks. The smart grid interconnects these sensors using digital information and communication technologies to collect and act on information. This information can include supplier and consumer behavior, allowing the smart grid to improve the distribution of fuel, such as electricity, in terms of efficiency, reliability, economy, production sustainability, and automated methods. The smart grid can be viewed as another sensor network with low latency.

The health sector has many applications that can benefit from mobile communications. Communication systems can support telemedicine to provide clinical care in remote locations. This can help to reduce barriers to distance and improve access to health services that are not continuously available in distant rural areas. It is also used to save lives in critical care and emergency situations. Mobile communication based wireless sensor networks can provide remote monitoring and sensors for parameters such as heart rate and blood pressure.

Wireless and mobile communications are becoming increasingly important in industrial applications. Wiring costs are high for installation and maintenance. Thus, the possibility of replacing a cable with a wireless link that can be reconfigured is an attractive opportunity in many industries. However, achieving this requires that wireless connections operate with similar delay, reliability, and capacity as cables and that their management is simplified. Low latency and very low error probabilities are new requirements that need to be connected to 5G.

Logistics and freight tracking are important use cases of mobile communications that enable tracking of inventory and packages anywhere using location-based information systems. Use cases of logistics and freight tracking typically require low data rates, but require a large range and reliable location information.

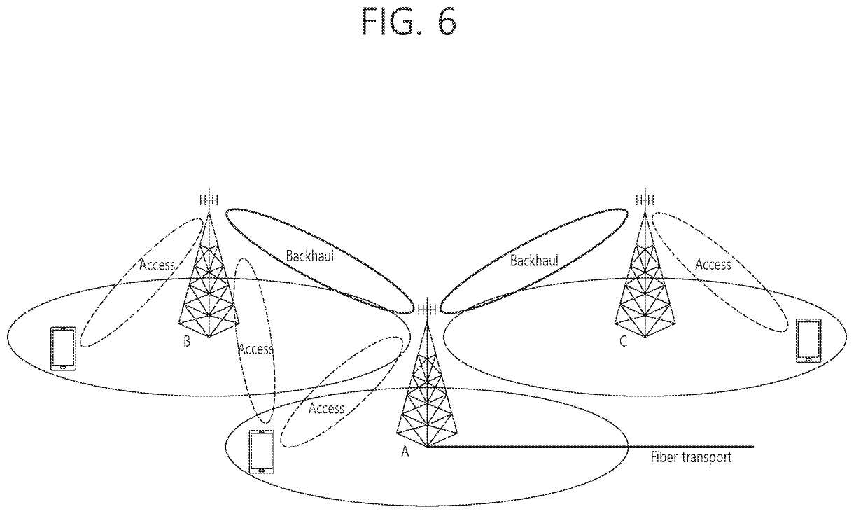

FIG. 6 schematically illustrates an example of integrated access and backhaul links.

An example of a network having such integrated access and backhaul links is shown in FIG. 6. Here, a relay node (rTRP) can multiplex access and backhaul links in time, frequency or space (e.g., beam based operation).

Operations of different links may be at the same frequency or different frequencies (which may also be referred to as “in-band” and “out-band” relays). Although efficient support of the out-band relay is important in some NR deployment scenarios, it is very important to understand in-band operation requirements that mean a close interaction with an access link operating at the same frequency in order to accept duplex constraint and prevent/mitigate interference.

In addition, operation of an NR system in mmWave spectrum can present some unique challenges including experiencing serious short-term blocking that may not be easily mitigated by a current RRC based handover mechanism due to a larger time scale necessary to complete a procedure than short-term blocking.

To overcome short-term blocking in the mmWave system, a fast RAN based mechanism (which does not necessarily require intervention of a core network) for switching between rTRPs.

Necessity for mitigating short-term blocking for NR operation in the mmWave spectrum along with requirement for easier deployment of a self-backhauled NR cell may cause necessity of development of an integrated framework that enables rapid switching of access and backhaul links.

In addition, over-the-air (OTA) coordination between rTRPs can be regarded as mitigation of interference and support of end-to-end route selection and optimization.

The following requirements and aspects may need to be solved by integrated access and backhaul (IAB) for NR
Efficient and flexible operation for in-band and out-band relays in indoor and outdoor scenarios
Multiple hops and redundant connection
End-to-end route selection and optimization
Support of backhaul link with high spectrum efficiency
Legacy NR UE support

Legacy new RAT was designed to support half-duplex devices. Further, half-duplex of an IAB scenario deserves to be supported and to become an object. In addition, a full-duplex IAB device can be researched.

In the IAB scenario, a donor gNB (DgNB) needs to schedule all links between related relay nodes (RNs) and UEs unless each RN has scheduling capability. In other words, the DgNB can collect traffic information in all related RNs, determine schedules with respect to all links and then notify each RN of schedule information.

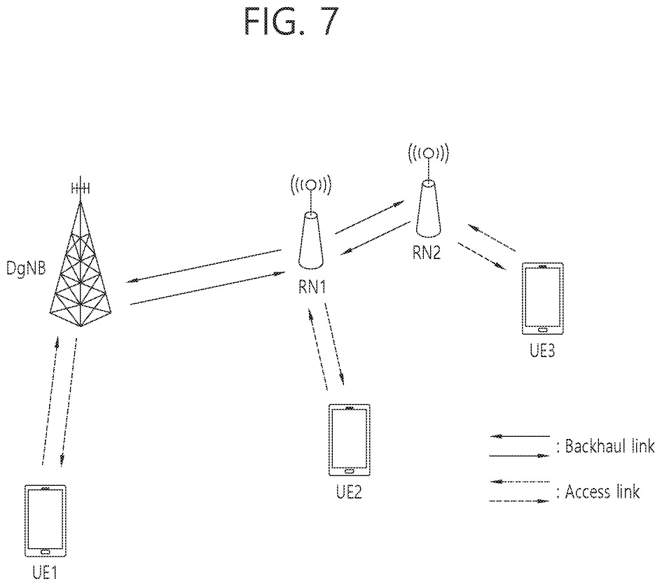

FIG. 7 schematically illustrates an example of a link between a DgNB, an RN, and a UE.

According to FIG. 7, for example, a link between DgNB and UE1 is an access link (access link), a link between RN1 and UE2 is also an access link, and a link between RN2 and UE3 may also mean an access link.

Similarly, according to FIG. 7, for example, a link between DgNB and RN1 and a link between RN1 and RN2 may mean a backhaul link.

For example, backhaul and access links can be configured, and m this case, the DgNB can receive scheduling requests of UE 2 and UE 3 as well as a scheduling request of UE 1. Then, the DgNB can determine scheduling of two backhaul links and three access links and signal the scheduling result. Accordingly, this centralized scheduling includes delayed scheduling and waiting time problems.

On the other hand, distributed scheduling can be performed if each RN has scheduling capability. Then, immediate scheduling can be performed for an uplink scheduling request of a UE and backhaul/access links can be used more flexibly in response to surrounding traffic conditions.

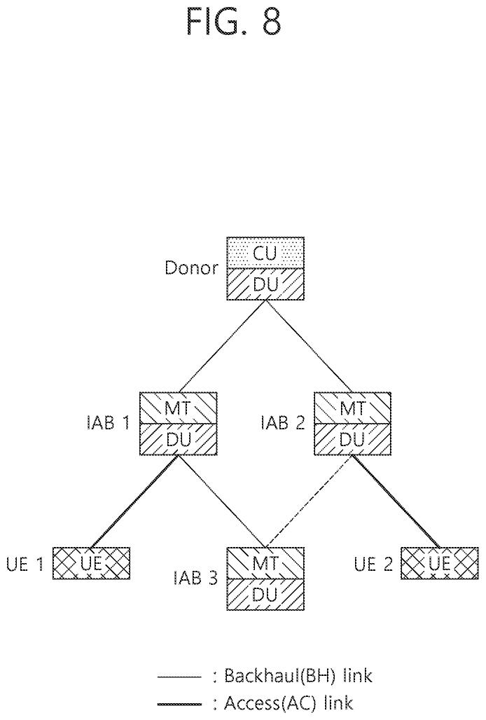

FIG. 8 schematically shows an example of a backhaul link and an access link.

As shown in FIG. 8, a link between a donor node and an IAB node or a link between IAB nodes is called a backhaul link. On the other hand, the link between the donor node and the UE or the link between the IAB node and the UE is called an access link. That is, a link between an MT and a parent DU or a link between a DU and a child MT may be referred to as a backhaul link, and a link between the DU and the UE may be referred to as an access link.

Hereinafter, the proposal of this specification is described.

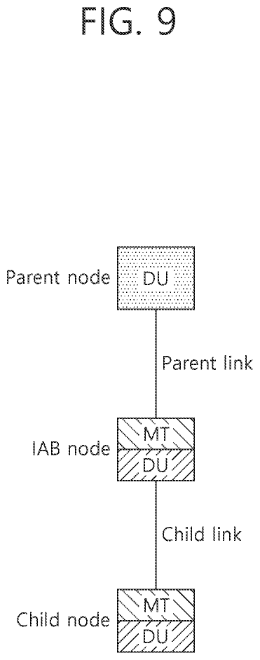

In the existing IAB node, the DU and the MT performed TDM operation through different time resources. On the other hand, it is required to perform resource multiplexing of SDM/FDM, FD (full duplexing), etc. between the DU and the MT for efficient resource management. FIG. 9, the link between the IAB node (IAB MT) and the parent node (parent DU) is referred to as a parent link, a link between an IAB node (IAB DU) and a child node (child MT) is called a child link. At this time, the TDM operation between the parent link and the child link has been previously discussed, and the SDM/FDM and FD operation are being discussed.

FIG. 9 schematically shows an example of a parent link and a child link.

As shown in FIG. 9, the link between the IAB node and the parent node is called a parent link, and the link between the IAB node and the child node/UE is called a child link. That is, the link between the MT and the parent DU is called a parent link, and the link between the DU and the child MT/UE is called a child link.

However, depending on the interpretation or perspective, the link between the IAB node and the parent node is called a backhaul link, and the link between the IAB node and the child node/UE is also called an access link.

The Tx/Rx timing alignment method of the IAB node that can be considered in the IAB environment may be as follows.

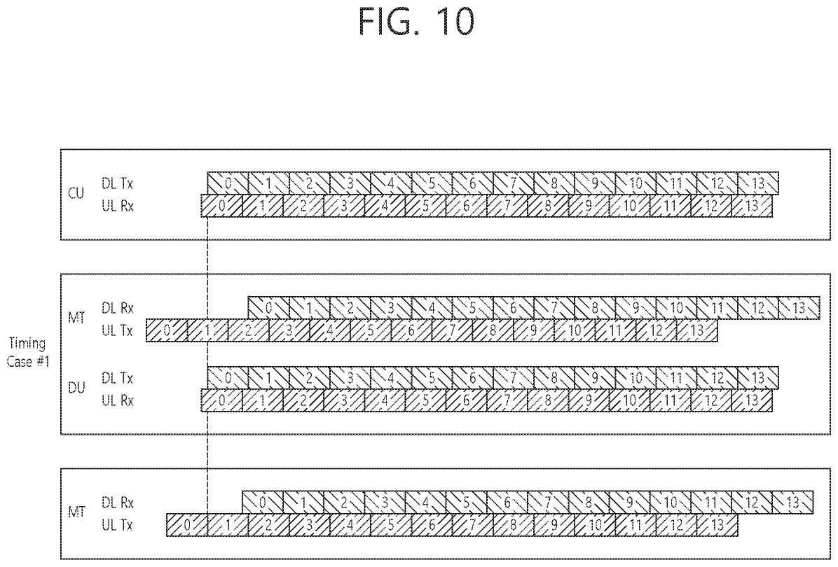

FIG. 10 schematically shows an example of timing alignment case 1.

Timing Alignment Case 1

DL transmission timing alignment across IAB-node(s) and IAB-donor(s). This is a method in which the DL Tx timing of DUs between IAB nodes is aligned, and is a timing alignment method used by Rel-16 IAB nodes.

If DL TX and UL RX are not well aligned at the parent node, additional information about the alignment is needed for the child node to properly set its DL TX timing for OTA based timing & synchronization.

MT Tx timing may be expressed as MT Rx timing−TA, the DU Tx timing may be expressed as MT Rx timing−TA/2−T_delta. The T_delta value is a value obtained from the parent node.

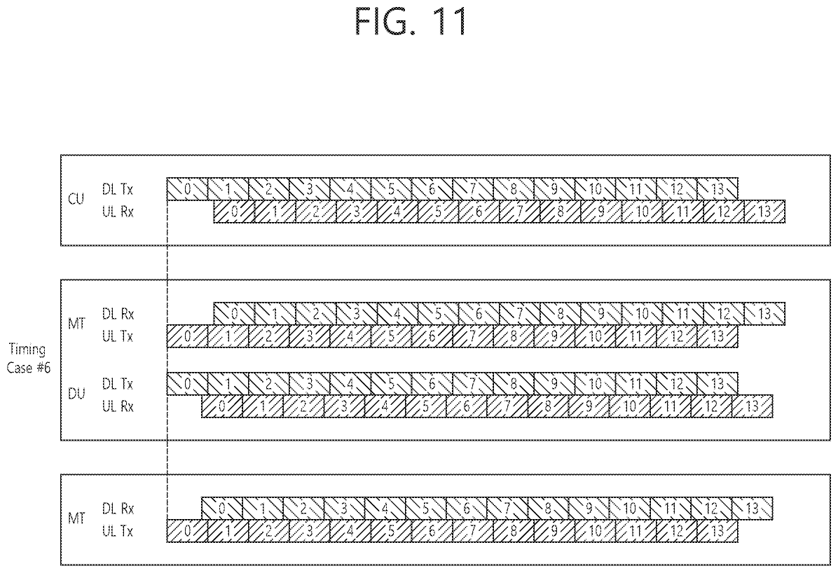

FIG. 11 schematically shows an example of timing alignment case 6.

Timing Alignment Case 6

The DL transmission timing for all IAB-nodes is aligned with the parent IAB-node or donor DL timing. The UL transmission timing of an IAB-node can be aligned with the IAB-node's DL transmission timing.

This is a method in which the MT UL Tx timing and the DU DL Tx timing of the IAB node are aligned.

Since the UL Tx timing of the MT is fixed, the UL Rx timing of the parent DU receiving it is delayed by the propagation delay of the parent DU and the MT compared to the UL Tx timing of the MT. The UL Rx timing of the MT varies according to the child MT that transmits the UL. When the IAB node uses the timing alignment case 6, since the UL Rx timing of the parent node is different from the existing one, if the IAB node wants to use the timing alignment case 6, the parent node also needs to know the corresponding information.

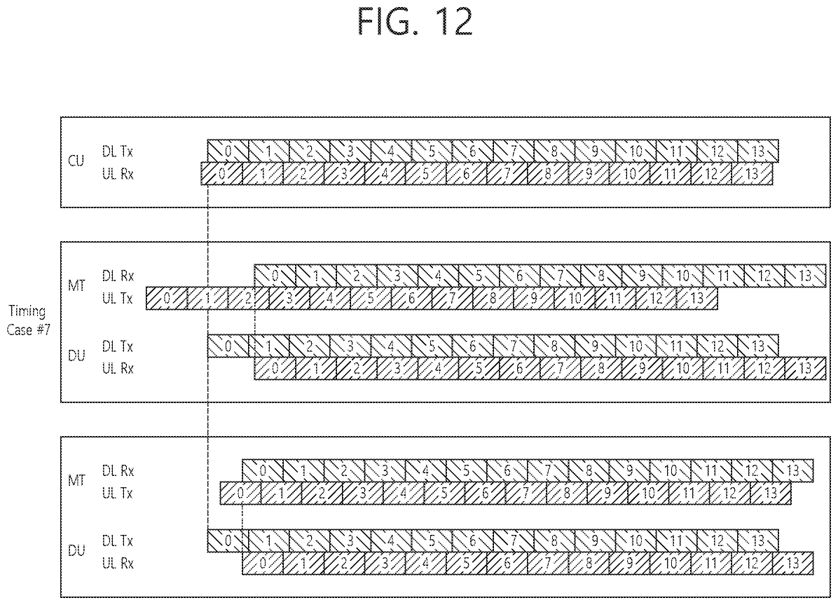

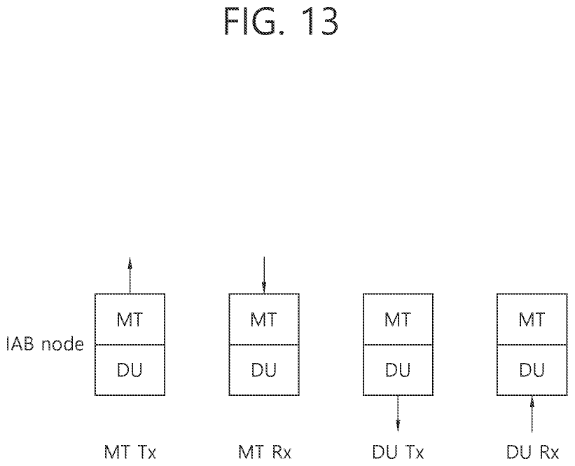

FIG. 12 schematically shows an example of a timing alignment case 7.

Timing Alignment Case 7

The DL transmission timing for all IAB-nodes is aligned with the parent IAB-node or donor DL timing. The UL reception timing of an IAB-node can be aligned with the IAB-node's DL reception timing.

If DL TX and UL RX are not well aligned at the parent node, additional information about the alignment is needed for the child node to properly set its DL TX timing for OTA based timing & synchronization.

This is a method in which the MT DL Rx timing and the DU UL Rx timing of the IAB node are aligned.

The transmission/reception timing from the MT perspective is the same as that of the existing IAB node (Rel-16 IAB node), the UL Rx timing of the DU may be aligned with the DL Rx timing of the MT. The IAB node needs to adjust the TA of the child MTs so that the child MTs transmit UL signals according to their UL Rx timing.

Therefore, this timing alignment method may not reveal a difference in the specification operation of the IAB node compared to the existing timing alignment method (case 1). Accordingly, the timing alignment case 7 described herein may be replaced/interpreted as the timing alignment case 1.

Examples for timing alignment cases 1, 6, and 7 are shown in FIGS. 13 to 15, respectively.

In this specification, timing alignment may mean slot-level alignment or symbol-level alignment.

Additional advantages, objects and features of the present specification will be set forth in part from the following description and in part will become apparent to those skilled in the art upon review of the following and may be learned from practice of the specification. The objectives and other advantages of this specification may be realized and attained by the structure particularly pointed out in the description and claims set forth herein, as well as in the accompanying drawings.

Configuration, operation and other features of this specification will be understood by the embodiments of this specification described with reference to the accompanying drawings.

The contents of this specification are described assuming an in-band environment, but may also be applied in an out-band environment. In addition, the contents of this specification are described in consideration of an environment in which a donor gNB (DgNB), a relay node (RN), and a UE perform a half-duplex operation, it can also be applied in an environment in which a donor gNB (DgNB), a relay node (RN), and/or UE perform a full-duplex operation.

According to this specification, various multiplexing options for MT and DU can be discussed during IAB SI. In addition, according to research, non-simultaneous operation between MT and DU can also be provided. According to the present specification, for Rel-17 IAB enh WI, simultaneous operation between MTs and DUs to increase spectrum efficiency and reduce latency may be included in the scope of work.

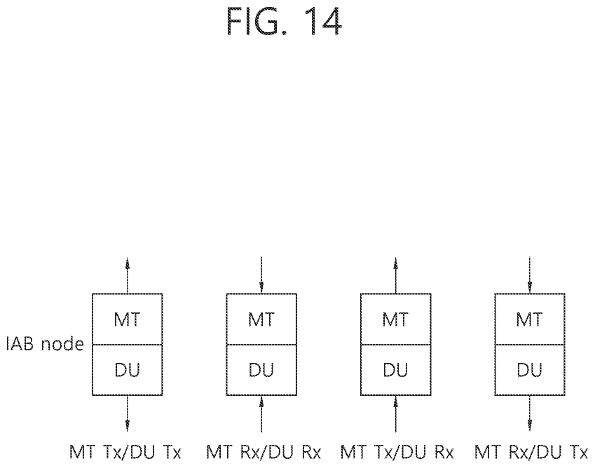

FIGS. 13 and 14 schematically illustrate an example of resource multiplexing among MTs and DUs.

For non-simultaneous operation, MTs and DUs can operate with the TDM method under the per-link half-duplex constraint as illustrated in FIG. 13. In case of simultaneous operation, MT and DU may perform Tx and/or Rx simultaneously as shown in FIG. 14.

For simultaneous operation of MTs and DUs, it can be assumed that MTs and DUs have independent panels and the amount of interference between panels is negligible (e.g., MTs and DUs are allocated separately). In this environment, it can be assumed that the parent and child links are physically separated, so simultaneous Tx and/or Rx can be performed without interference between links. Accordingly, timing alignment for simultaneous Tx and/or Rx may not be required.

On the other hand, an environment in which antenna panels for MT and DU coexist or antenna panels for MT and DU are shared may also be considered. If so, the effect of interference between the upper link and the lower link must be considered for simultaneous operation. In this environment, the following multiplexing method can be considered according to the combination of MT and DU transmission directions.

A. MT-Tx/DU-Tx or MT-Rx/DU-Rx

(1) SDM

Simultaneous Tx or Rx between MT and DU can be performed by SDM method. For receiver-side SDM, orthogonality between DL DMRS and UL DMRS is important to successfully separate the two Rx signals. Timing alignment between MT-Rx and DU-Rx is required for DMRS orthogonality, and related schemes need to be discussed.

When MT and DU receive PDSCH and PUSCH, respectively, DMRS for PDSCH and DMRS for PUSCH can be allocated orthogonally. Therefore, the IAB node can receive both channels simultaneously. However, SDM for other combinations of DL and UL channels is not suitable because orthogonal DMRS assignments cannot be used. Therefore, SDM for simultaneous reception can be used in limited cases such as PDSCH and PUSCH reception.

(2) FDM

FDM can be another option for simultaneous Tx or Rx between MT and DU within the carrier bandwidth. One important way to ensure that the parent and child links utilize different frequency resources is to separate the frequency resources at the BWP level. For example, when the MT of the IAB-node performs uplink transmission within the uplink BWP, the DU of the IAB-node can utilize the downlink BWP composed of frequency resources that do not overlap with the uplink BWP of the MT.

Even if the frequency resources for the parent and child links are separated, the received signals of the parent and child links may interfere with each other according to the amount of interference emission for the adjacent frequency resources. Rx timing alignment between MT and DU may be required if the interference level is not low enough. However, if the Rx power between the MT and the DU is properly scaled and an appropriate amount of guard resource is assumed between the MT and the DU's frequency resources, timing alignment between MT and DU Rx may not be required.

B. Full Duplex for MT-Tx/DU-Rx or MT-Rx/DU-Tx

For simultaneous Tx and Rx between MT and DU, intra-device interference (i.e., MT-Tx to DU-Rx or DU-Tx to MT-Rx) must be considered. Compared to Rx to Rx interference in the case of simultaneous reception, the IAB node may experience stronger interference because the Tx signal arrives at the Rx antenna without path loss. Therefore, the interference level for adjacent frequency resources can be much higher than in the case of simultaneous reception. Therefore, such interference can occur not only when MTs and DUs share frequency resources, but also when they utilize separated frequency resources. In order to solve the intra-device interference problem, the timing alignment between the DU and the MT is required to perform the interference mitigation technique, which is a basic requirement for applying the interference mitigation technique.

In the present specification, a method for performing multiplexing (simultaneous operation) by the MT and DU of the IAB node using the SDM method is proposed.

DMRS for PDSCH/PUSCH

The DMRS for PDSCH/PUSCH is composed of a front load DMRS and an additional DMRS.

Front Load DMRS

The transmission time resource location of the front load DMRS is determined by the following factors.
It may vary, depending on whether the mapping type (PDSCH mapping type/PUSCH mapping type) of the data channel is Type A or Type B (slot based or non-slot based), a mapping type is configured through RRC.
In the case of slot-based transmission, the transmission start OFDM symbol position of the front load DMRS may be the 3rd or 4th OFDM symbol of data transmission resources, an indication of whether the transmission start OFDM symbol position is the third OFDM symbol or the fourth OFDM symbol is transmitted through the PBCH.
The front load DMRS can consist of 1 or 2 consecutive OFDM symbols, whether the number of OFDM symbols is 1 or 2 is configured through RRC.

The mapping type within the transmission OFDM symbol resource of the front load DMRS can have two types (type 1 or type 2), information on the applied type is configured as RRC. For type 1, using F-CDM (CDM in frequency domain), T-CDM (CDM in time domain), and/or FDM techniques, depending on whether the DMRS symbol length is 1 or 2, 4 or 8 antenna port(s) are supported, respectively. In the case of type 2, 6 or 12 antenna port(s) are supported depending on whether the DMRS symbol length is 1 or 2 using F-CDM, T-CDM, and/or FDM techniques.

Additional DMRS

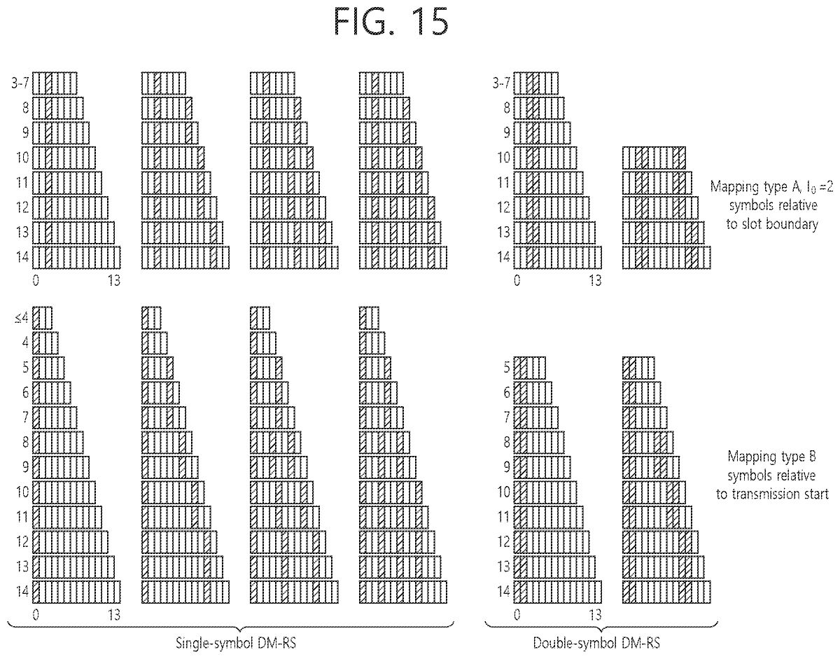

FIG. 15 schematically illustrates an example of an additional DMRS.

The number of additional DMRSs is determined among 0, 1, 2, or 3. The maximum number of additional DMRS transmitted is determined through RRC, the number of actually transmitted additional DMRSs and transmission OFDM symbol positions within each maximum number of DMRSs are determined according to the length of OFDM symbols through which data is transmitted. The symbol locations of the front load DMRS and the additional DMRS according to the data symbol length are shown in FIG. 15.

The number of OFDM symbols and mapping type of each additional DMRS are determined identically to the number of OFDM symbols and mapping type of front load DMRS.

A. Orthogonal DMRS Mapping for MT and DU

When MT and DU in IAB node transmit and/or receive data using SDM within the same time/frequency resource, for example, MT receives PDSCH through parent link, when a DU receives PUSCH through a child link, when the DMRS of the two PDSCHs and the DMRS of the PUSCH are transmitted orthogonally, the MT and the DU can accurately perform channel estimation for PDSCH reception and channel estimation for PUSCH reception, respectively.

To this end, when the MT and DU of the IAB node receive PDSCH and PUSCH, respectively (or when MT and DU transmit PUSCH and PDSCH, respectively), the specification proposes a method for orthogonal transmission of DMRS of PDSCH and PUSCH.

Alignment of DMRS OFDM Symbol Resources

In order for PDSCH DMRS and PUSCH DMRS received by MT and DU to be transmitted orthogonally (or PUSCH DMRS and PDSCH DMRS transmitted by MT and DU, respectively), different CDM groups (i.e., FDM, different RE/subcarrier resources) and/or different orthogonal sequence(s) must be used in the same OFDM symbol. When the DMRSs of the MT and DU are transmitted through different OFDM symbols, they collide with each other's data transmission resources and suffer interference. For example, if the OFDM symbol of the PUSCH DMRS received by the MT is located in the OFDM symbol of the PDSCH rather than the OFDM symbol of the DMRS received by the DU, the PDSCH signal transmitted to the DU acts as interference to the PUSCH DMRS received by the MT

Therefore, the OFDM symbol positions of the PDSCH DMRS and PUSCH DMRS received by the MT and DU, respectively (or the OFDM symbol positions of the PUSCH DMRS and PDSCH DMRS transmitted by the MT and DU, respectively) need to be the same. To this end, we suggest the following method. For the orthogonality of the two DMRS, all or part of the following methods may be applied in combination.

(1) In order to align the OFDM symbol positions of the two front load DMRSs applied to MT and DU, both PDSCH/PUSCH mapping types may have type A.
For this purpose, the IAB node must be configured with type A as the mapping type of MT's PDSCH (PUSCH). Also, for the DU of the IAB node, the child MT/UE must also have PUSCH (PDSCH) mapping type configured as type A. In this case, the IAB node may determine that orthogonal (orthogonal) DMRS reception/transmission is possible.
Or, if the IAB node performs simultaneous (simultaneous) Rx or Tx of data between MT and DU through SDM, it can be assumed that both the PDSCH (PUSCH) mapping type of the MT and the PUSCH (PDSCH) mapping type of the DU have type A.

(2) To align the OFDM symbol positions of the two front load DMRSs applied to the MT and DU, the OFDM symbol positions of the front load DMRS must be the same.

To this end, if the mapping type of PDSCH/PUSCH is type A, the position of the starting OFDM symbol of the front load DMRS that the IAB node MT receives through PBCH and the position of the starting OFDM symbol of the front load DMRS that the IAB node DU configures to the child MT/UE through the PBCH must be the same.
To this end, the IAB node DU can configure the position of the starting OFDM symbol of the front load DMRS configured through the PBCH to be the same as the position of the starting OFDM symbol of the front load DMRS applied to the IAB node MT.
Alternatively, when the position of the starting OFDM symbol of the front load DMRS configured by the IAB node MT through the PBCH and the position of the starting OFDM symbol of the front load DMRS configured by the IAB node DU to the child MT/UE through the PBCH are the same, the IAB node may determine that orthogonal DMRS reception/transmission is possible.

Alternatively, when the mapping type of PDSCH/PUSCH is type B, transmission start of PDSCH/PUSCH received/transmitted by MT and DU (resource mapping start) OFDM symbol positions must be the same.
To this end, if the resource mapping start OFDM symbol position of data transmitted and received by the IAB node MT is the same as the resource mapping start OFDM symbol position of data transmitted and received by the DU, the IAB node may determine that orthogonal (orthogonal) DMRS reception/transmission is possible.
Or, to increase the likelihood that OFDM symbol position where resource mapping of data scheduled by parent node to IAB node MT and data resource mapping start OFDM symbol position when IAB node DU schedules data to child MT/UE are aligned, when a DU schedules data, the resource mapping start OFDM symbol position of the data may be limited. For example, data mapping may be restricted to start only at ODFM symbol index #0 or #7. Information on the OFDM symbol position where resource mapping of such data can start is configured as RRC/F1-AP. etc. by the donor node/CU, or it can be configured through MAC/DCI signaling by the parent node.

(3) To align the position of OFDM symbols of DMRS applied to MT and DU, the OFDM symbol length of the front load DMRS and each additional DMRS must be the same. To this end, the OFDM symbol length of the DMRS configured by the IAB node MT must be the same as the OFDM symbol length of the DMRS applied to the child MT/UE.
For this purpose, if the OFDM symbol length of the DMRS configured by the IAB node MT is the same as the OFDM symbol length of the DMRS applied to the child MT/UE, the IAB node may determine that orthogonal DMRS reception/transmission is possible.
Alternatively, a specific OFDM symbol length may be equally applied to the DMRS of the MT and DU of the IAB node. An OFDM symbol length value of such a DMRS may be fixed to a specific value and described in a specification.

(4) To align positions of additional DMRSs applied to MTs and DUs, the maximum number of additional DMRSs applied for additional DMRSs of MTs and DUs must be configured identically.
To this end, the maximum number of additional DMRS configured by the MT of the IAB node and the maximum number of additional DMRS applied to the child MT/UE must be configured identically. In this case, the IAB node may determine that orthogonal DMRS reception/transmission is possible.
Alternatively, the IAB node may assume/determine the maximum number of additional DMRSs applied to the MT and the maximum number of additional DMRSs applied to the child MT/UE as specific values. The maximum number of these additional DMRSs may be fixed to a specific value and described in the specification.

(5) To align positions of additional DMRSs applied to MTs and DUs, the number of additional DMRSs applied to MTs and DUs and the transmission OFDM symbol positions of the additional DMRSs must be the same.
To this end, the IAB node, when the number and OFDM symbol positions of additional DMRS transmitted applied to the MT and the number of OFDM symbols transmitted by additional DMRS applied to the DU and OFDM symbol position are the same, it can be determined that orthogonal (orthogonal) DMRS reception/transmission is possible.
Alternatively, a specific number of additional DMRSs and OFDM symbol locations may be applied to MTs and DUs. These additional DMRS numbers and OFDM symbol locations can be determined as follows.
Additional DMRS numbers and OFDM symbol locations for simultaneous operation of MTs and DUs can be described in the specification. In this case, the number of additional DMRSs and OFDM symbol positions may be determined differently for each maximum number of additional DMRSs.
The number of additional DMRSs and OFDM symbol positions are determined according to the maximum number of additional DMRSs and the transmission symbol length of the data channel. Therefore, the IAB node can configure the assumed data symbol length to determine the position of the OFDM symbol of the additional DMRS of the MT and DU. This information can be configured through RRC or configured through DCI. In addition, the IAB node can configure the data symbol length assumed to determine the location of the OFDM symbol of the additional DMRS for its child MT/UE through DCI. This data symbol length is used to determine the symbol position of the additional DMRS, not the symbol length through which actual data is transmitted.

Orthogonal DMRS Pattern Application Method

As described above, when MTs and DUs in an IAB node transmit and/or receive data using SDM within the same time/frequency resource, for example, when an MT receives a PDSCH through a parent link and a DU receives a PUSCH through a child link, when the DMRS of the two PDSCHs and the DMRS of the PUSCH are transmitted orthogonally, the MT and the DU can accurately perform channel estimation for PDSCH reception and channel estimation for PUSCH reception, respectively. However, because the parent node schedules the data transmitted and received by the MT, and the IAB-DU performs the scheduling of the data transmitted and received by the DU. Two DMRSs may be located non-orthogonal, and in this case, smooth SDM operation may not be possible.

When the MT receives the PDSCH through the parent link and the DU receives the PUSCH through the child link, in order for the DMRS of the two PDSCHs and the DMRS of the PUSCH to be transmitted orthogonally, the specification proposes a method for aligning DMRS transmission symbol positions between MT and DU and a method and apparatus for applying an orthogonal DMRS pattern.

Hereinafter, for a better understanding of the examples of the present specification, the disclosure of the present specification will be described through drawings. The following drawings are made to explain a specific example of the present specification. Since the names of specific devices or names of specific signals/messages/fields described in the drawings are provided as examples, the technical features of the present specification are not limited to the specific names used in the drawings below.

The following embodiments may operate together with the previously described embodiments of the present specification (unless configurations are contradictory to each other). In addition, the following embodiments may operate independently of the previously described embodiments of the present specification.

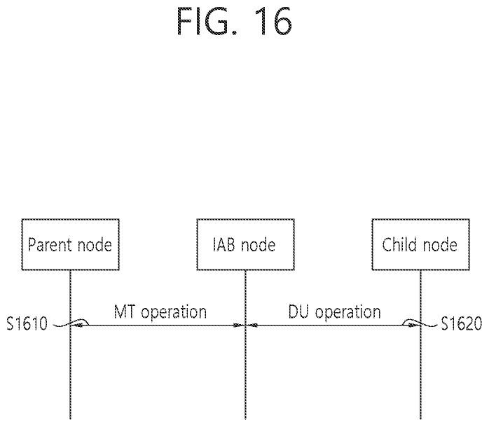

FIG. 16 is a flowchart of a method of performing an MT operation and a DU operation according to an embodiment of the present specification.

According to FIG. 16, the IAB node may perform MT operation with the parent node (S1610). Since a more specific embodiment of this is the same as described above (and will be described later), repeated description of redundant content will be omitted for convenience of description.

The IAB node may perform the DU operation with the child node (S1620). Since a more specific embodiment of this is the same as described above (and will be described later), repeated description of redundant content will be omitted for convenience of description.

Here, a first demodulation reference signal (DMRS) may be applied to the MT operation, and a second DMRS may be applied to the DU operation. For example, DMRS ports belonging to different code division multiplexing (CDM) groups may be applied to each of the first DMRS and the second DMRS. Since a more specific embodiment of this is the same as described above (and will be described later), repeated description of redundant content will be omitted for convenience of description.

For example, the MT operation may be an operation related to communication between the IAB node and the child node, and the DU operation may be an operation related to communication between the IAB node and the parent node. Since a more specific embodiment of this is the same as described above (and will be described later), repeated description of redundant content will be omitted for convenience of description.

For example, the child node may be another IAB node or user equipment (UE). Since a more specific embodiment of this is the same as described above (and will be described later), repeated description of redundant content will be omitted for convenience of description.

For example, the IAB node may receive configured information on the CDM group of the second DMRS for the DU operation. Since a more specific embodiment of this is the same as described above (and will be described later), repeated description of redundant content will be omitted for convenience of description.

Here, for example, information on the CDM group may be configured from a centralized unit (CU) or donor node through radio resource control (RRC) or F1 application protocol (F1-AP). Since a more specific embodiment of this is the same as described above (and will be described later), repeated description of redundant content will be omitted for convenience of description.

Here, for example, information on the CDM group may be configured from the parent node through medium access control (MAC) or downlink control information (DCI). Since a more specific embodiment of this is the same as described above (and will be described later), repeated description of redundant content will be omitted for convenience of description.

Here, for example, the IAB node selects a DMRS port in a DMRS port index having a CDM group value included in the CDM group information, the IAB node may perform the DU operation based on the selected DMRS port. Since a more specific embodiment of this is the same as described above (and will be described later), repeated description of redundant content will be omitted for convenience of description.

Here, for example, the IAB node may assume that the DMRS port of the MT operation is determined among DMRS ports using a CDM group other than at least one CDM group available for the DU operation. Since a more specific embodiment of this is the same as described above (and will be described later), repeated description of redundant content will be omitted for convenience of description.

To help understand the specification, the CDM group is described in more detail as follows.

Unless there is no CSI-RS configuration and is configured otherwise, the UE may assume that the PDSCH DM-RS and SS/PBCH blocks are quasi co-located with respect to Doppler shift, Doppler spread, average delay, delay spread, and spatial Rx parameters if applicable. The UE may assume that PDSCH DM-RSs in the same CDM group are quasi co-located with respect to Doppler shift, Doppler spread, average delay, delay spread, and spatial Rx. The UE may assume that the DMRS port associated with the PDSCH is QCL type A, type D (if applicable) and QCL with average gain.

And, the UE can assume that no DM-RS collides with the SS/PBCH block.

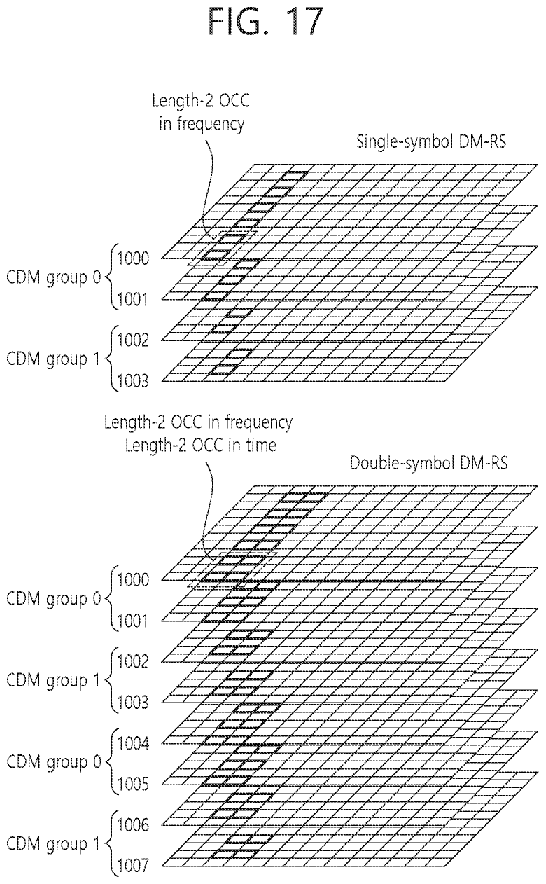

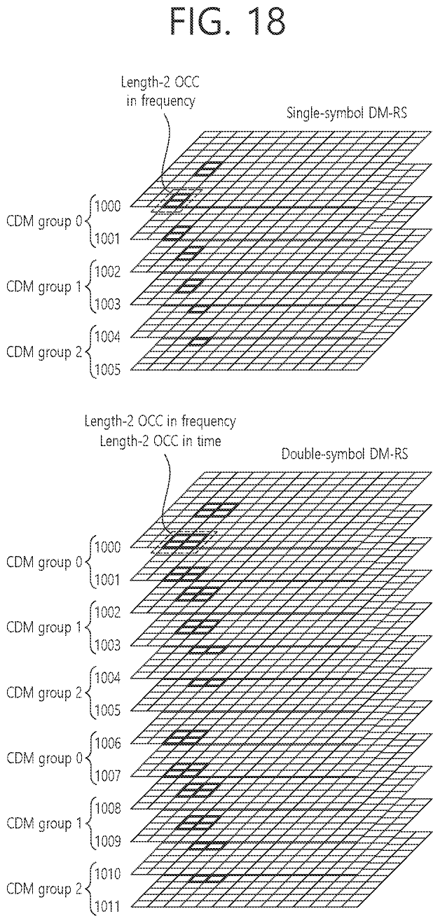

FIG. 17 illustrates an example of PDSCH DMRS configure type 1, and FIG. 18 illustrates an example of PDSCH DMRS configure type 2.

Here, an example of the PDSCH DMRS configure type may be described as follows. First, examples of parameters of PDSCH DMRS configure type 1 may be shown in Table 4, and examples of parameters of PDSCH DMRS configure type 2 may be shown in Table 5.

TABLE 4

| | | |
|---|---|---|
| CDM | w_f(k′) | w_t(l′) |

| p | groupλ | Δ | k′ = 0 | k′ = 1 | l′ = 0 | l′ = 1 |
|---|---|---|---|---|---|---|
| 1000 | 0 | 0 | +1 | +1 | +1 | +1 |
| 1001 | 0 | 0 | +1 | −1 | +1 | +1 |
| 1002 | 1 | 1 | +1 | +1 | +1 | +1 |
| 1003 | 1 | 1 | +1 | −1 | +1 | +1 |
| 1004 | 0 | 0 | +1 | +1 | +1 | −1 |
| 1005 | 0 | 0 | +1 | −1 | +1 | −1 |
| 1006 | 1 | 1 | +1 | +1 | +1 | −1 |
| 1007 | 1 | 1 | +1 | −1 | +1 | −1 |

TABLE 5

| | | |
|---|---|---|
| CDM | w_f(k′) | w_t(l′) |

| p | groupλ | Δ | k′ = 0 | k′ = 1 | l′ = 0 | l′ = 1 |
|---|---|---|---|---|---|---|
| 1000 | 0 | 0 | +1 | +1 | +1 | +1 |
| 1001 | 0 | 0 | +1 | −1 | +1 | +1 |
| 1002 | 1 | 2 | +1 | +1 | +1 | +1 |
| 1003 | 1 | 2 | +1 | −1 | +1 | +1 |
| 1004 | 2 | 4 | +1 | +1 | +1 | +1 |
| 1005 | 2 | 4 | +1 | −1 | +1 | +1 |
| 1006 | 0 | 0 | +1 | +1 | +1 | −1 |
| 1007 | 0 | 0 | +1 | −1 | +1 | −1 |
| 1008 | 1 | 2 | +1 | +1 | +1 | −1 |
| 1009 | 1 | 2 | +1 | −1 | +1 | −1 |
| 1010 | 2 | 4 | +1 | +1 | +1 | −1 |
| 1011 | 2 | 4 | +1 | −1 | +1 | −1 |

In summary, 2 or 4 ports can belong to one CDM group. Here, if the CDM group is different, the DMRS transmission subcarrier position (A value) can be configured differently. Ports belonging to the same CDM group can maintain orthogonality with each other by applying different orthogonal codes (e.g. (w_f, w_t)). Hereinafter, specific embodiments of the present specification will be described in more detail.

In order for the DU of the IAB node and the DMRS received or transmitted by the MT to be orthogonal, a plurality of DMRSs within the same OFDM symbol may be orthogonally transmitted using methods of F-CDM, T-CDM, and/or FDM. The following method can be applied to orthogonally transmit the DMRS applied to the DU and MT of the IAB node within the same OFDM symbol. For the orthogonality of the two DMRS, all or part of the following methods may be applied in combination.

(1) In order to apply orthogonal DMRS to MT and DU, the same DMRS mapping type can be applied to MT and DU. There are two types of DMRS mapping type, type 1 and type 2. Depending on the DMRS mapping type, the number of supported DMRS ports and the number and location of DMRS transmission RE resources for each port are applied differently. Therefore, the DMRS mapping type configured for the MT and DU of the IAB node must be configured identically. In this case, the IAB node may determine that orthogonal DMRS reception/transmission is possible. Alternatively, it can be assumed that a specific DMRS mapping type is applied for orthogonal DMRS application to MT and DU. This DMRS type can be fixed as a specific type and defined in the specification.

(2) When the DMRS applied to MT and DU applies different CDM groups (i.e., FDM, different RE/subcarrier resources) or different orthogonal sequences within the same CDM group, orthogonal transmission of two DMRSs can be achieved. To this end, the following methods may be specifically applied.

The CDM group and orthogonal sequence applied for the parent link of the MT are determined/instructed by the parent node, the CDM group and orthogonal sequence applied for the child link of the DU are determined/instructed by the IAB node DU. At this time, these CDM groups and orthogonal sequences are determined through a DMRS antenna port. At this time, in order to apply orthogonal DMRS to MT and DU, a DMRS antenna port that can be configured for the MT and a DMRS antenna port that the DU can apply for child link can be selected so that different CDM groups and/or orthogonal sequences are applied. For example, the DMRS port index of PDSCH may be selected from port indexes of {1000, 1001, 1002, . . . , 1007}, the PUSCH DMRS port index may be selected from port indexes of {0, 1, 2 . . . . , 7}. At this time, the DMRS antenna port indexes of the MT and DU may be selected to have different ‘port index mod 100’ values or ‘port index mod 1000’ values. For example, for MT, DMRS using an antenna port with a ‘port index mod 100’ value or a ‘port index mod 1000’ value of {0, 1, 2, 3} can be used, for DU, DMRS using antenna ports with a ‘port index mod 100’ value or a ‘port index mod 1000’ value of {4, 5, 6, 7} can be used. To this end, the IAB node can configure a ‘port index mod 100’ value or a ‘port index mod 1000’ value that can use DMRS port index information that can be used by the DU. That is, for DMRS orthogonality between the MT and the DU, the DMRS port that the DU of the IAB node can use for DMRS transmission and reception on the child link may be limited. This configure information can be configured through RRC/F1-AP or the like. Alternatively, it can be configured with MAC/DCI, etc. through the parent node.

When the IAB node configures the DMRS port index information that the DU can use, a DMRS port can be selected from the corresponding DMRS port indices and used for DMRS transmission/reception on a child link. At this time, the IAB node may assume that the DMRS port of the MT is determined by excluding DMRS ports that can be used by the DU.

(3) In the case of differentiated DMRS transmissions by applying the CDM technique, orthogonality can be maintained when using the same sequence.

(4) In the case of DMRS transmissions in a CDM relationship with each other, orthogonality may not be maintained when the same sequence is not used. To this end, DMRS configured with different subcarrier resources (i.e., in FDM relationship) can be applied to the MT and DU of the IAB node. This may mean that DMRS ports belonging to different CDM groups are applied to DMRS applied to MT and DU.

To this end, the CDM group of DMRS that can be configured in the MT and the CDM group of DMRS that can be applied to the DU for child link can be selected from values that do not overlap with each other. To this end, the IAB node can configure CDM group information of DMRS that can be used by DUs. That is, for DMRS orthogonality between the MT and the DU, the CDM group of the DMRS that the DU of the IAB node can use may be limited. This configure information can be configured through RRC/F1-AP through CU/donor. Alternatively, it can be configured with MAC/DCI, etc. through the parent node.

When the IAB node configures the CDM group information of the DMRS that can be used by the DU, it can select a DMRS port in the DMRS port index having the CDM group value included in the configure and use it for DMRS transmission and reception on the child link. At this time, the IAB node may assume that the DMRS port of the MT is determined among DMRS ports using a CDM group that does not correspond to CDM groups that can be used by the DU.

Hereinafter, for a better understanding of the examples of the present specification, the disclosure of the present specification will be described through drawings. The following drawings are made to explain a specific example of the present specification. Since the names of specific devices or names of specific signals/messages/fields described in the drawings are provided as examples, the technical features of the present specification are not limited to the specific names used in the drawings below.

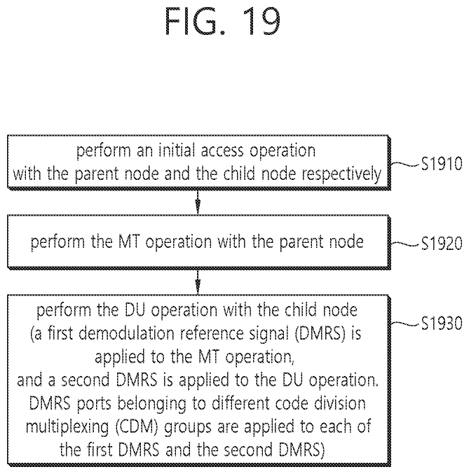

FIG. 19 is a flowchart of a method of performing an MT operation and a DU operation according to another embodiment of the present specification.

According to FIG. 19, the IAB node may perform an initial access operation with the parent node and the child node respectively (S1910). Since a more specific embodiment of this is the same as described above (and will be described later), repeated description of redundant content will be omitted for convenience of description.

The IAB node may perform the MT operation with the parent node (SI 920). Since a more specific embodiment of this is the same as described above (and will be described later), repeated description of redundant content will be omitted for convenience of description.

The IAB node may perform the DU operation with the child node (S1930). Since a more specific embodiment of this is the same as described above (and will be described later), repeated description of redundant content will be omitted for convenience of description.

Here, a first demodulation reference signal (DMRS) may be applied to the MT operation, and a second DMRS may be applied to the DU operation. For example, DMRS ports belonging to different code division multiplexing (CDM) groups may be applied to each of the first DMRS and the second DMRS. Since a more specific embodiment of this is the same as described above (and will be described later), repeated description of redundant content will be omitted for convenience of description.

According to the present specification, for example, when an MT receives a PDSCH through a parent link and a DU receives a PUSCH through a child link, the DMRS of two PDSCHs and the DMRS of the PUSCH can be transmitted orthogonally, accordingly, the MT and the DU can accurately perform channel estimation for PDSCH reception and channel estimation for PUSCH reception, respectively.

Effects obtainable through specific examples of the present specification are not limited to the effects listed above. For example, there may be various technical effects that a person having ordinary skill in the related art can understand or derive from this specification. Accordingly, the specific effects of the present specification are not limited to those explicitly described in the present specification, and may include various effects that can be understood or derived from the technical features of the present specification.

On the other hand, the contents to which the above-described examples are applied may be described as follows from various subject points of view.

The following drawings are made to explain a specific example of the present specification. Since the names of specific devices or names of specific signals/messages/fields described in the drawings are provided as examples, the technical features of the present specification are not limited to the specific names used in the drawings below.

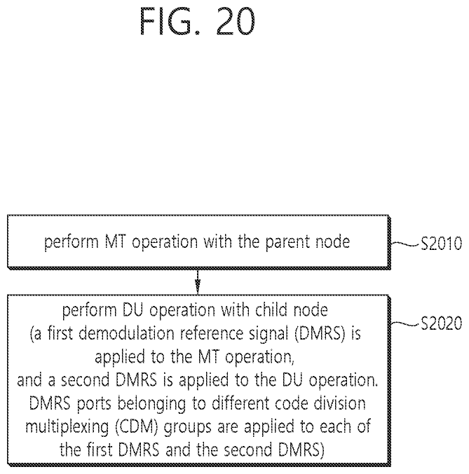

FIG. 20 is a flowchart of a method of performing an MT operation and a DU operation (from the perspective of an IAB node) according to an embodiment of the present specification.

According to FIG. 20, the IAB node may perform MT operation with the parent node (S2010). Since a more specific embodiment of this is the same as described above (and will be described later), repeated description of redundant content will be omitted for convenience of description.

The AB node may perform DU operation with child node (S2020). Since a more specific embodiment of this is the same as described above (and will be described later), repeated description of redundant content will be omitted for convenience of description.

Here, a first demodulation reference signal (DMRS) may be applied to the MT operation, and a second DMRS may be applied to the DU operation. For example, DMRS ports belonging to different code division multiplexing (CDM) groups may be applied to each of the first DMRS and the second DMRS. Since a more specific embodiment of this is the same as described above (and will be described later), repeated description of redundant content will be omitted for convenience of description.

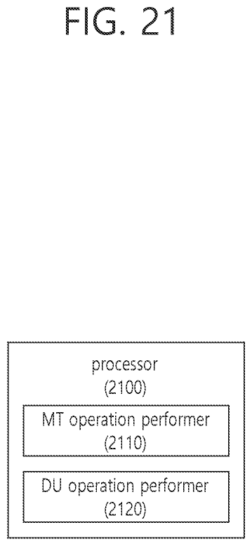

FIG. 21 is a block diagram of an example of a device performing an MT operation and a DU operation (from the perspective of an IAB node) according to an embodiment of the present specification.

According to FIG. 21, a processor 2100 may include an MT operation performer 2110 and a DU operation performer 2120. An example of a processor to be described later may be applied to the processor herein.

The MT operation performer 2110 may be configured to perform an MT operation with a parent node. Since a more specific embodiment of this is the same as described above (and will be described later), repeated description of redundant content will be omitted for convenience of description.

The DU operation performer 2120 may be configured to perform a DU operation with a child node. Since a more specific embodiment of this is the same as described above (and will be described later), repeated description of redundant content will be omitted for convenience of description.

Here, a first demodulation reference signal (DMRS) may be applied to the MT operation, and a second DMRS may be applied to the DU operation. For example, DMRS ports belonging to different code division multiplexing (CDM) groups may be applied to each of the first DMRS and the second DMRS. Since a more specific embodiment of this is the same as described above (and will be described later), repeated description of redundant content will be omitted for convenience of description.

On the other hand, although not shown separately, the present specification also provides the following embodiments.

As an example, an Integrated Access and Backhaul (IAB) node that performs a mobile terminal (MT) operation and a distributed unit (DU) operation may comprise a transceiver, at least one memory and at least one processor operably coupled with the at least one memory and the transceiver, the at least one processor configured to perform an initial access operation with a parent node and a child node, respectively, perform the MT operation with the parent node and perform the DU operation with the child node, wherein a first demodulation reference signal (DMRS) is applied to the MT operation, and a second DMRS is applied to the DU operation, and wherein each of the first DMRS and the second DMRS is respectively applied with a DMRS port belonging to a different code division multiplexing (CDM) group. Since a more specific embodiment of this is the same as described above (and will be described later), repeated description of redundant content will be omitted for convenience of description.

As an example, an apparatus may comprise at least one memory and at least one processor operably coupled with the at least one memory, the at least one processor configured to perform an initial access operation with a parent node and a child node, respectively, perform mobile terminal (MT) operation with the parent node and perform distributed unit (DU) operation with the child node, wherein a first demodulation reference signal (DMRS) is applied to the MT operation, and a second DMRS is applied to the DU operation, and wherein each of the first DMRS and the second DMRS is respectively applied with a DMRS port belonging to a different code division multiplexing (CDM) group. Since a more specific embodiment of this is the same as described above (and will be described later), repeated description of redundant content will be omitted for convenience of description.

As an example, at least one computer readable medium containing instructions based on being executed by at least one processor may be the at least one processor configured to perform an initial access operation with a parent node and a child node, respectively, perform mobile terminal (MT) operation with the parent node and perform distributed unit (DU) operation with the child node, wherein a first demodulation reference signal (DMRS) is applied to the MT operation, and a second DMRS is applied to the DU operation, and wherein each of the first DMRS and the second DMRS is respectively applied with a DMRS port belonging to a different code division multiplexing (CDM) group. Since a more specific embodiment of this is the same as described above (and will be described later), repeated description of redundant content will be omitted for convenience of description.

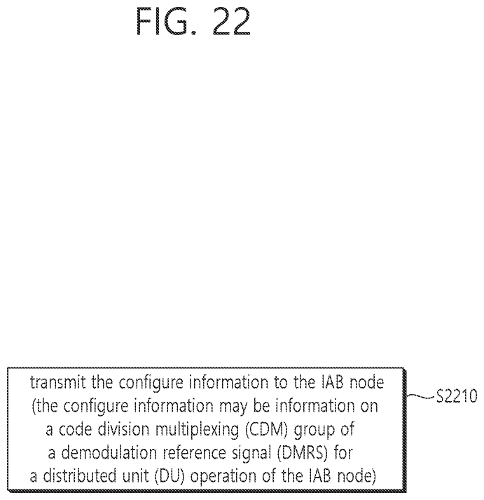

FIG. 22 is a flowchart of a method of transmitting configure information (from a node point of view) according to an embodiment of the present specification.

According to FIG. 22, the node may transmit the configure information to the IAB node (S2210). Here, the configure information may be information on a code division multiplexing (CDM) group of a demodulation reference signal (DMRS) for a distributed unit (DU) operation of the IAB node. Since a more specific embodiment of this is the same as described above (and will be described later), repeated description of redundant content will be omitted for convenience of description.

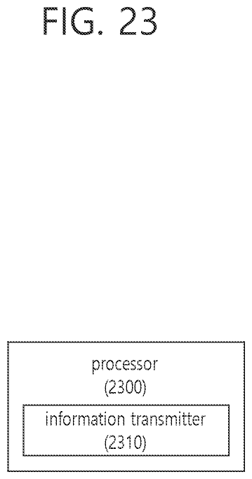

FIG. 23 is a block diagram of an example of a device for transmitting configure information (from a node point of view) according to an embodiment of the present specification.

According to FIG. 23, the processor 2300 may include an information transmitter 2310. An example of a processor to be described later may be applied to the processor herein.

The information transmission unit 2310 may be configured to transmit the configure information to the IAB node. Here, the configure information may be information on a code division multiplexing (CDM) group of a demodulation reference signal (DMRS) for a distributed unit (DU) operation of the IAB node. Since a more specific embodiment of this is the same as described above (and will be described later), repeated description of redundant content will be omitted for convenience of description.

On the other hand, although not shown separately, the present specification also provides the following embodiments.

As an example, a node may comprise a transceiver, at least one memory and at least one processor operably coupled with the at least one memory and the transceiver, the at least one processor configured to perform an initial access operation with an Integrated Access and Backhaul (IAB) node and control the transceiver to transmit configuration information to the IAB node, wherein the configuration information is information for a code division multiplexing (CDM) group of a demodulation reference signal (DMRS) for a distributed unit (DU) operation of the IAB node. Since a more specific embodiment of this is the same as described above (and will be described later), repeated description of redundant content will be omitted for convenience of description.

Data Symbol/RE Puncturing

When PDSCH DMRS and PUSCH DMRS received by MT and DU, respectively (or PUSCH DMRS and PDSCH DMRS transmitted by MT and DU, respectively) are transmitted through OFDM symbols that are not identical to each other, they collide with each other's data transmission resources and experience interference. In order to reduce this interference effect, it can be assumed that the DU (MT) receives a PUSCH (PDSCH) punctured and transmitted in an OFDM symbol or RE resource in which the DMRS received by the MT (DU) is transmitted. Alternatively, the DU (MT) may puncture and transmit the PDSCH (PUSCH) it transmits in an OFDM symbol or RE resource in which the DMRS transmitted by the MT (DU) is transmitted.

To this end, the IAB node DU (MT) needs to know information about OFDM symbols or RE resource locations of DMRS received and/or transmitted by the MT (DU). Alternatively, the IAB node DU (MT) may inform or be instructed the location of a resource to be punctured in data transmission/reception in order to prevent collision with DMRS transmission/reception of the MT (DU). To this end, the following methods may be applied.

(1) When the MT (DU) transmits data, the DMRS transmitted by the DU (MT) may transmit data by puncturing a transmission resource (OFDM symbol or RE).

In this case, the MT may inform the parent of the resource location where puncturing is performed on the PUSCH transmission. This indication may be included in PUSCH and transmitted, or may be transmitted through another channel/signal such as PUCCH.

The DU may inform the child node/access UE of the location of the resource where puncturing is performed on transmission of the PDSCH. In this indication, for example, DCI format 2_0 may be reused. Alternatively, this indication may be included in DCI scheduling the corresponding PDSCH or DCI scheduling the retransmitted PDSCH and transmitted.

(2) The IAB node MT may be configured with a resource location to perform puncturing on PUSCH transmission in order to avoid a collision between the DMRS transmitted by the DU and the PUSCH resource transmitted by the IAB node MT. This indication may be indicated through DCI scheduling the PUSCH or through MAC/RRC signaling. Alternatively, the location of a resource to perform puncturing may be configured through MAC/RRC, and whether or not to actually apply puncturing may be instructed through DCI.

(3) For IAB node MT, in order to avoid collision between the DMRS received by the DU and the PUSCH resource it receives, a location of a resource to which puncturing is applied to PDSCH reception may be configured. For this indication, for example, DCI format 2_0 may be reused. Alternatively, this indication may be included in DCI scheduling the corresponding PDSCH or DCI scheduling the retransmitted PDSCH and transmitted. Alternatively, such puncturing resource information may be instructed through MAC/RRC signaling. Alternatively, the location of a resource to perform puncturing may be configured through MAC/RRC, and whether or not to actually apply puncturing may be instructed through DCI.

In the above, puncturing can be interpreted as being replaced with rate-matching.

Meanwhile, in the present specification, a configuration for a transmission puncturing instruction may also be provided, and the contents of the transmission puncturing instruction will be described in more detail below.

In the present specification, when the IAB-node DU/IAB-node MT fails to transmit the promised signal/channel due to a power sharing problem, the specification proposes a method for improving the reception performance of a receiver by informing the location of a puncturing resource of a signal/channel transmitted by itself.

In this specification, timing alignment may mean slot-level alignment or symbol-level alignment.

For reasons such as intra-node interference, slot/symbol boundary misalignment, power sharing, etc., DUs and MTs existing in the same IAB node (or co-located) cannot operate simultaneously but can operate through TDM.

On the other hand, multiplexing of SDM/FDM between DU and MT may be used. This is applicable when, for example, DU and MT use different panels and there is little interference between panels. In this case, DUs and MTs existing in the same IAB node (or co-located) can transmit or receive simultaneously, it is impossible for DU and MT to perform transmission and reception or reception and transmission simultaneously.

Alternatively, full duplexing (FD) may be used between the DU and the MT. This is applicable when there is little interference effect between the DU and the MT, for example, when the frequency domain in which the DU operates is far from the frequency domain in which the MT operates. In this case, DUs and MTs existing in the same IAB node (or co-located) can freely transmit and receive simultaneously. DU and MT can transmit or receive simultaneously, it is also possible for the DU and MT to transmit and receive or receive and transmit simultaneously.

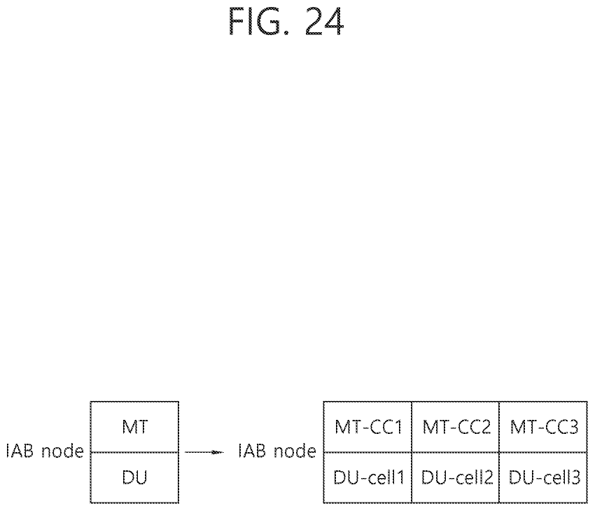

FIG. 24 schematically illustrates an example of MTs and DUs in an IAB node.

The MT and DU of the IAB node may be composed of a plurality of component carriers (CCs). In this case, different CCs may operate in the same or different frequency domains or use the same or different panels. For example, as shown in FIG. 24, each MT and DU in the IAB node may have three CCs. In the figure, the three CCs that exist in the MT are named MT-CC1, MT-CC2, and MT-CC3, respectively. In the case of a DU, CC is replaced with a cell and is called DU-Cell 1, DU-Cell 2, and DU-Cell 3.

In this case, one multiplexing method among TDM, SDM/FDM, and FD may be applied between a specific CC of the MT and a specific cell of the DU. For example, when a specific MT-CC and a DU-cell are located in different inter-band frequency domains, FD can be applied between the MT-CC and the DU-cell. On the other hand, the TDM method may be applied between the MT-CC and the DU-CC located in the same frequency domain. In FIG. 24, MT-CC1, MT-CC2, DU-Cell 1, and DU-Cell 2 have f1 as a center frequency, MT-CC3, DU-cell 3 has f2 as the center frequency, f1 and f2 may be located within an inter-band. In this case, from the standpoint of MT-CC1 (or from the standpoint of MT-CC2), TDM operates with DU-Cell 1 and DU-Cell 2, but can operate as FD with DU-Cell 3. On the other hand, from the standpoint of MT-CC3, DU-Cell 1 and DU-Cell 2 operate in FD, but DU-Cell 3 can operate in TDM.

On the other hand, different multiplexing methods between MT and DU may be applied even within the same CC. For example, a plurality of parts may exist in an MT-CC and/or DU-cell. These parts may mean, for example, antennas having the same center frequency but different physical locations or links transmitted to different panels. Alternatively, for example, it may refer to links having the same center frequency but transmitted through different BWPs. In this case, for example, when there are two parts in DU-cell 1, a multiplexing type operating with a specific MT-CC or a specific part in a specific MT-CC may be different for each part. The following specification describes the case where the multiplexing type applied to each pair of MT CC and DU cells may be different, the contents of the specification can be extended and applied even when MTs and DUs are divided into a plurality of parts and multiplexing types applied to pairs of CCs and parts of MTs and cells and parts of DUs may be different.

It may be considered that one IAB node is connected to two or more parent nodes. At this time, the IAB MT may be connected to the two parent DUs using the DC (dual-connectivity) method.

An IAB node may have redundant paths to the IAB donor CU. For an IAB node operating in SA mode, NR DC is used to enable path redundancy at the BH by allowing the IAB-MT to have coexisting BH RLC channels with two parent nodes. The parent node must be connected to the same IAB donor CU-CP that controls the configure and release of redundant paths through these two parent nodes. The parent node together with the IAB donor CU gets the role of master node and auxiliary node of IAB-MT. The NR DC framework (e.g. MCG/SCG related procedures) is used to configure a dual wireless link with the parent node.

The following scenario can be considered as a method in which the IAB MT is connected to two parent DUs.

Scenario 1. Multiple Parent DU Connections Using Different MT-CCs with Adjacent Carrier Frequencies

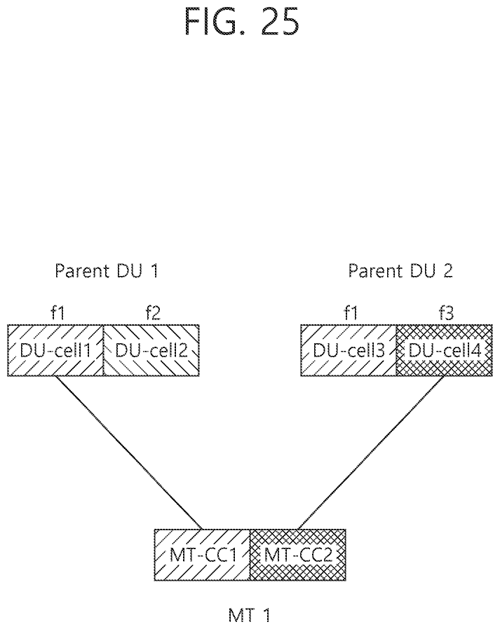

FIG. 25 schematically illustrates an example for scenario 1.

An IAB MT can establish a connection with multiple parent DUs using different MT-CCs. That is, one MT-CC is connected to one parent DU-cell, and the corresponding parent DU-cells may exist in different parent DUs. For example, as shown in FIG. 25, MT-CC1 and MT-CC2 exist in the IAB MT, MT-CC1 is connected to DU-cell 1 in parent DU1, MT-CC2 can be connected to DU-cell 4 in parent DU2. At this time, from the viewpoint of IAB MT, a link between one MT-CC and one DU-cell is referred to as one parent link. In this case, the link between MT-CC1 and DU-cell 1 and the link between MT-CC2 and DU-cell 4 become different parent links.

In this way, the existing dual-connectivity (DC) method can be used to establish a connection with DU-cells in different parent DUs using different MT-CCs. In this case, when the IAB MT is connected to two parent DU-cells using different MT-CCs, one parent DU-cell belongs to the MCG and the remaining parent DU-cells belong to the SCG.

It can be assumed that each MT-CC of the IAB MT has an independent RF chain. Therefore, each MT-CC can perform Tx/Rx operations independently of each other and simultaneously. Each MT-CC configures and manages Tx/Rx timing based on the parent DU-cell connected to it.

In Scenario 1, it is considered that MT-CCs connected to different parent DUs operate at different carrier frequencies in the above situation. That is, in FIG. 25, the link between MT-CC1 and DU-cell 1 and the link between MT-CC2 and DU-cell 4 have different carrier frequencies. In FIG. 25, the link between MT-CC1 and DU-cell 1 has a carrier frequency of f1, while the link between MT-CC2 and DU-cell 4 has a carrier frequency of f3. In this case, carrier frequency domains operating between the two parent links may be adjacent to each other. In this case, when parent links operate in different D/U directions, cross link interference may occur. In this scenario, a situation in which cross-link interference occurs to the extent that affects performance due to adjacent carrier frequency domains between two parent links is considered.

Scenario 2. Multiple Parent DU Connections Using Different MT-CCs with the Same Carrier Frequency

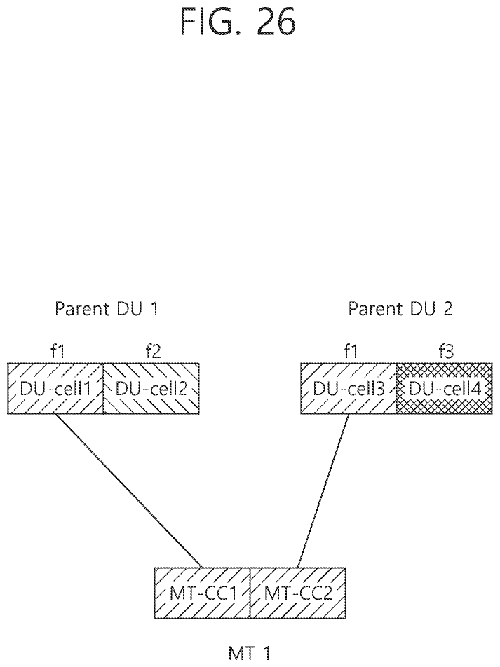

FIG. 26 schematically illustrates an example for scenario 2.

An IAB MT can establish a connection with multiple parent DUs using different MT-CCs. That is, one MT-CC is connected to one parent DU-cell, and the corresponding parent DU-cells may exist in different parent DUs. For example, as shown in FIG. 26, MT-CC1 and MT-CC2 exist in IAB MT, MT-CC1 is connected to DU-cell 1 in parent DU1, MT-CC2 can be connected to DU-cell 3 in parent DU2. At this time, from the viewpoint of the IAB MT, a link between one MT-CC and one DU-cell is referred to as one parent link. In this case, the link between MT-CC1 and DU-cell 1 and the link between MT-CC2 and DU-cell 3 become different parent links.

In this way, the existing dual-connectivity (DC) method can be used to establish a connection with DU-cells in different parent DUs using different MT-CCs. In this case, when the IAB MT is connected to two parent DU-cells using different MT-CCs, one parent DU-cell belongs to the MCG and the remaining parent DU-cells belong to the SCG.

It can be assumed that each MT-CC of the IAB MT has an independent RF chain. Therefore, each MT-CC can perform Tx/Rx operations independently of each other and simultaneously. Each MT-CC configures and manages Tx/Rx timing based on the parent DU-cell connected to it.

In scenario 2, it is considered that MT-CCs connected to different parent DUs operate at the same carrier frequency in the above situation. That is, in FIG. 26, consider a situation in which a link between MT-CC1 and DU-cell 1 and MT-CC2 and DU-cell 3 have the same carrier frequency. That is, in this scenario, different MT-CCs within the IAB MT can operate with the same carrier frequency, this means that a plurality of MT-CCs may exist in the same frequency domain. In FIG. 26, the link between MT-CC1 and DU-cell 1 has a carrier frequency of f1, and the link between MT-CC2 and DU-cell 3 also has a carrier frequency of f1. At this time, cross-link interference may occur when parent links operate in different D/U directions. In addition, when resources in which actual DL signals/channels are transmitted through two MT-CCs overlap each other, they may act as interference with each other. Even in the case of UL, when UL signals/channels transmitted by two MT-CCs overlap, a UL signal/channel transmitted to a specific parent DU may act as interference to another parent DU.

Scenario 3. Multiple Parent DU Connections Using a Single MT-CC

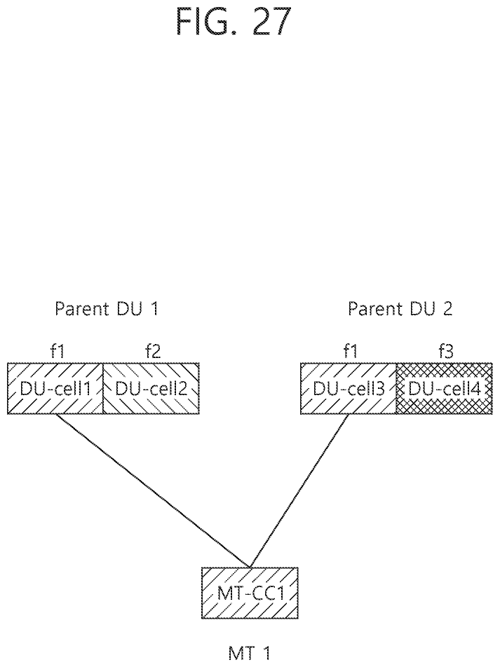

FIG. 27 schematically illustrates an example for scenario 3.

An IAB MT can establish a connection with multiple parent DUs using one MT-CC. That is, one MT-CC is connected to a plurality of parent DU-cells, and the corresponding parent DU-cells may exist in different parent DUs. For example, as shown in FIG. 27, MT-CC1 exists in IAB MT, and MT-CC1 can be connected to DU-cell 1 in parent DU1 and DU-cell 4 in parent DU2. At this time, from the viewpoint of IAB MT, a link between one MT-CC and one DU-cell is referred to as one parent link. In this case, the link between MT-CC1 and DU-cell 1 and the link between MT-CC1 and DU-cell 4 become different parent links. In FIG. 27, the link between MT-CC1 and DU-cell 1 has a carrier frequency of f1, and the link between MT-CC1 and DU-cell 3 also has a carrier frequency of f1.

Scenario 3-1. Multiple Parent DU Connections with Multiple RF Module(s)

One MT-CC in the IAB MT can have multiple RF chains. That is, one MT-CC can support different parent DUs on the same carrier frequency using two RF modules. In this case, MT-CC supports one but independent RF modules and can connect with multiple parent DUs at the same time. Accordingly, MT-CCs can independently and simultaneously perform Tx/Rx operations for a plurality of parent DUs. Each RF module of MT-CC configures and manages Tx/Rx timing based on the parent DU-cell connected to it. At this time, cross-link interference may occur when parent links operate in different D/U directions. In addition, when resources through which actual DL signals/channels are transmitted through two parent links overlap each other, they may act as interference. Even in the case of UL, when UL signals/channels transmitted through two parent links overlap, a UL signal/channel transmitted to a specific parent DU may act as interference to other parent DUs.

Scenario 3-2. Multiple Parent DU Connection with Single RF Module

One MT-CC in an IAB MT can have one RF chain. Accordingly, the MT-CC may not be able to transmit/receive simultaneously with two parent links operating at different Tx/Rx timings. In addition, simultaneous transmission and reception may not be performed with two parent links operating in different analog beam directions. Therefore, the MT-CC must perform operations to different parent links using different time resources. At this time, the MT-CC must independently configure and manage the Tx/Rx timing for each parent DU connected to it.

Scenario 4. DAPS HO (Dual Active Protocol Stack Based Handover)

DAPS HO has been introduced for mobility enhancement of the UE. This DAPS HO can also be applied to IAB MT. When DAPS HO is applied, when the MCG currently connected to the UE is referred to as the source MCG and the MCG to be handover is referred to as the target MCG, the UE can be simultaneously connected to the source MCG and the target MCG using the same carrier frequency. When the IAB MT establishes a connection with a plurality of parent DUs using the same carrier frequency, the DAPS HO method may be used. In this case, the two parent DUs may be connected by using one parent DU as the source MCG and the other parent DU as the target MCG.

The content proposed in this specification is based on configuring and operating two parent DUs as MCG and SCG, respectively, it may include operating as a DAPS HO with MCG and SCG as source MCG and target MCG (or target MCG and source MCG), respectively. In this case, it can be interpreted by replacing MCG and SCG mentioned in this specification with source MCG and target MCG (or target MCG and source MCG), respectively.

The contents of this specification are described assuming an in-band environment, but may also be applied in an out-band environment. In addition, the content of this specification is described in consideration of an environment in which a donor gNB (DgNB), a relay node (RN), and a UE perform half-duplex operation, it can also be applied in an environment in which a donor gNB (DgNB), relay node (RN), and/or UE perform full-duplex operation.

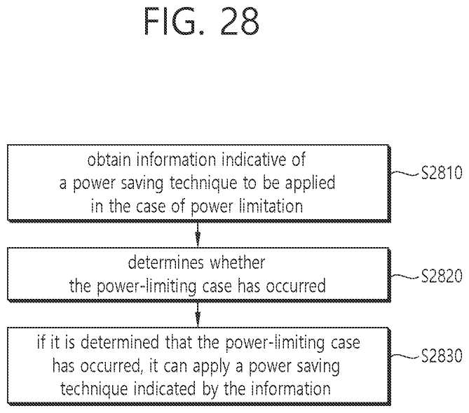

FIG. 28 shows an example of a method of operating an IAB node.

Referring to FIG. 28, the IAB node may obtain information indicative of a power saving technique to be applied in the case of power limitation (S2810). Here, the power limitation case may mean a case in which the total power value of specific transmission(s) to be performed by the IAB node is greater than the maximum transmission power of the IAB node. For example, in a section where the IAB node intends to simultaneously perform i) MT UL Tx operation with P_MT power value and ii) DU DL Tx operation with P_DU power value, if the value of P_MT+P_DU is greater than P_max_IAB, which is the maximum transmission power that the IAB node can perform, it can be referred to as a power limiting case. However, in FIG. 28, a case in which the IAB node obtains information indicating a power saving technique to be applied in a power limitation case is exemplified, but is not limited thereto. That is, even if information indicating the power saving technique is not explicitly obtained/received, it is possible to apply the predetermined power saving technique when a predetermined situation occurs.

The IAB node determines whether the power-limiting case has occurred (S2820), and if it is determined that the power-limiting case has occurred, it can apply a power saving technique indicated by the information (S2830). The IAB node can determine whether or not a power limitation case has occurred based on transmission resource configuration on the MT side, transmission resource configuration on the DU side, transmission power of the MT on the corresponding resource, and transmission power of the DU on the corresponding resource. If it is determined that a power limiting case occurs, at least one of the methods described later (e.g., a method of not transmitting an MT or a DU, a method of reducing transmission power of an MT and/or DU, or a combination thereof) may be applied.

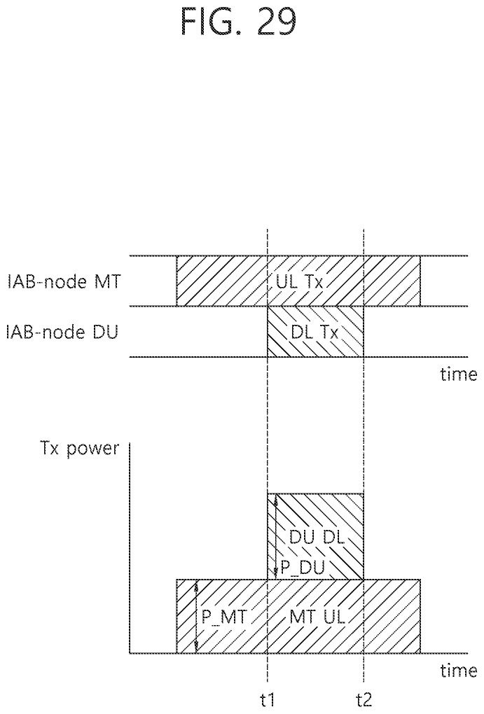

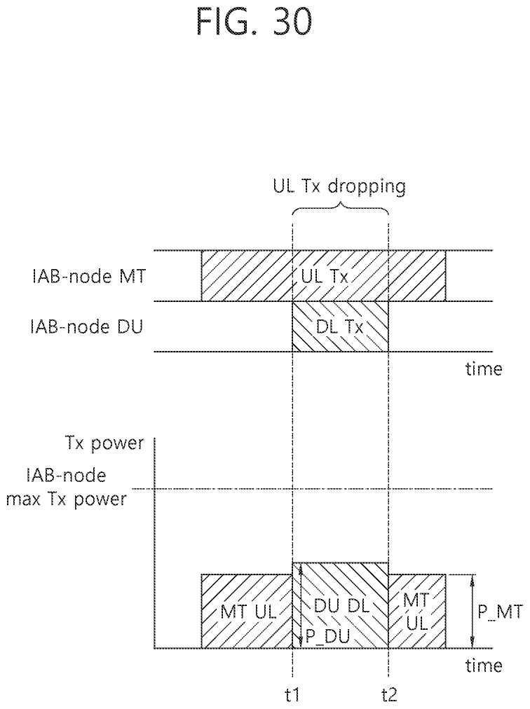

FIGS. 29 and 30 show an example of a case where the MT and DU of the IAB-node simultaneously perform UL Tx operations and DL Tx operations, respectively.

In this specification, consider the case where the MT and DU of the IAB-node simultaneously perform UL Tx operations and DL Tx operations, respectively. As in the example shown in FIG. 29, when the IAB-node MT and the IAB-node DU perform UL Tx operations and DL Tx operations, respectively, in the time interval between t1 and t2, the UL Tx operation of the MT and the DL Tx operation of the DU may be performed simultaneously. At this time, the transmission power of MT and DU may be equal to P_MT and P_DU, respectively. At this time, in the section where MT and DU perform UL Tx operation and DL Tx operation simultaneously, the value of P_MT+P_DU, which is the total Tx power of the IAB node, must be smaller than P_max_IAB, which is the maximum transmit power that the IAB node can perform.

If the value of P_MT+P_DU is greater than P_max_IAB in a section where MT and DU simultaneously perform UL Tx and DL Tx operations, the following method can be considered.

1) MT or DU transmission is not performed. That is, only one of the UL Tx of the MT or the DL Tx of the DU is transmitted.

2) Reduce transmit power of MT and/or DU. That is, the values of P_MT and/or P_DU are adjusted so that P_MT+P_DU is equal to or less than P_max_IAB.

For example, as shown in FIG. 30, in the time interval between t1 and t2 where MT and DU simultaneously perform UL Tx operation and DL Tx operation, when the value of P_MT+P_DU is greater than P_max_IAB, only the DL Tx operation of the DU may be performed without performing the UL Tx operation of the MT.

As above, when the IAB-node MT (IAB-node DU) performs the Tx operation of a specific signal/channel, in all or part of the transmission time interval of the corresponding signal/channel, transmission may not be performed due to the Tx operation of the IAB-node DU (IAB-node MT). In this way, if transmission cannot be performed in part/full time interval of transmission of IAB-node MT or IAB-node DU specific signal/channel, IAB-node MT or IAB-node can operate as follows.

1) IAB-node MT (IAB-node DU) stops transmission of the corresponding signal/channel. That is, the IAB-node MT does not perform all or remaining transmissions even when transmission cannot be performed only in some time intervals during which transmission of the corresponding signal/channel is performed. In this case, if the IAB-node MT recognizes that transmission of the corresponding signal/channel cannot be performed in the partial/full time period during which transmission of the corresponding signal/channel is performed prior to transmission of the corresponding signal/channel, do not perform full transmission. Or, if the IAB-node MT recognizes that transmission of the corresponding signal/channel cannot be performed during part/full time interval during transmission of the corresponding signal/channel, do not perform the remaining transfers. That is, in the examples of FIGS. 29 and 30, even if the IAB-node MT cannot perform UL Tx transmission only in the time interval t1 to t2 in the transmission interval of the corresponding UL signal/channel, transmission of the corresponding UL signal/channel may not be performed.

2) The IAB-node MT (IAB-node DU) stops transmission of the corresponding signal/channel only in the time interval during which transmission of a specific signal/channel cannot be performed. If the IAB-node MT cannot perform transmission only in a part of the time period in which the transmission of the corresponding signal/channel is performed, in the corresponding time interval, signal/channel transmission is punctured or rate-matched, and signal/channel transmission is performed in the remaining time interval. That is, in the examples of FIGS. 29 and 30, when the IAB-node MT cannot perform UL Tx transmission in the time interval t1 to t2 among the transmission intervals of the corresponding UL signal/channel, transmission of the UL signal/channel may be punctured or rate-matched in the corresponding time interval, and transmission of the corresponding UL signal/channel may be performed in the remaining interval.

Hereafter, puncturing/punctured in this specification may be interpreted as being replaced with rate-matching/rate-matched.

As above, when IAB-node MT and/or DU operates, the UL signal/channel of the MT and/or the DL signal/channel of the DU may be punctured without being transmitted in all or part of the transmission time interval. When a receiver receiving a signal/channel transmitted in this way does not know that the signal/channel has been punctured in some transmission resources, since the receiver uses the noise value of the punctured resource together for reception, it may not be successfully received or the measurement through the corresponding signal may not be accurately performed. In the case of PDSCH/PUSCH, etc., after the receiver fails to receive PDSCH/PUSCH transmitted by puncturing or rate-matching in some transmission resources, thereafter, decoding may be performed by receiving the retransmitted PDSCH/PUSCH. In this case, the previously received noise value is continuously used for decoding, which may degrade reception performance.

Considering this situation, if the receiver can know the punctured resource location of the previously received signal/channel, reception performance can be improved by excluding the corresponding resource during decoding to attempt reception of a retransmitted signal/channel or retrying reception of a previous signal/channel.

In order to solve the problems described above, the specification proposes a method for informing the IAB-node DU and child IAB-node MT and/or the IAB-node MT to the parent IAB-node DU of the location of the puncturing resource of the signal/channel it transmits.

In this specification, the child IAB-node MT may be interpreted/applied by being replaced with an access UE.

A. Indicating Method of Puncturing Resource Location.

In this section, when a transmitter transmits a signal/channel to a receiver, the specification proposes a method for notifying a receiver of the location of a resource that has not been punctured and transmitted during transmission of a corresponding signal/channel. In this specification, if the transmitter is an IAB-node DU, the receiver becomes a child IAB-node MT, if the transmitter is the IAB-node MT, the receiver can be the parent IAB-node DU.

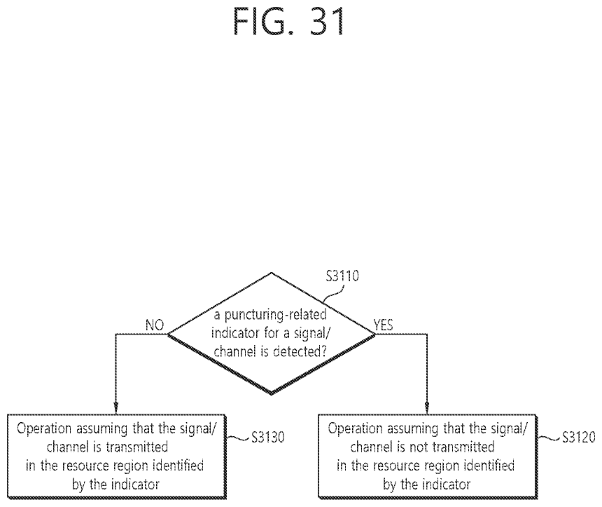

FIG. 31 illustrates a method of operation of a device according to the present specification.

According to FIG. 31, the device may attempt to detect a puncturing-related indicator for a signal/channel (S3110). For example, the indicator may be transmitted by an MT of an IAB node or a DU of an IAB node. A channel through which the indicator can be transmitted may vary depending on the transmission entity. This will be described in detail later.

The device that has detected/received the indicator may operate assuming that the signal/channel is not transmitted in the resource region identified by the indicator (S3120). A device that has not detected/received the indicator may operate assuming that the signal/channel is transmitted in the resource region identified by the indicator (S3130). The resource region identified by the indicator may vary according to methods 1, 2, and 3 below.

Method 1. Indicates Whether to Puncture the Entire Transmission of the Signal/Channel

The transmitter may inform the receiver of whether the corresponding signal/channel is actually transmitted (in the entire OFDM symbol region) in all resources through which the specific signal/channel is transmitted. More specifically, the following instructions may be used for this purpose.

1) It can indicate that the signal/channel is not transmitted through a specific indication. That is, when a specific indication is transmitted (detection), it may mean that transmission of a signal/channel is not performed. Alternatively, it may indicate that a signal/channel has been transmitted through a specific indication. That is, when a specific indication is transmitted (if found), it may mean that transmission of a signal/channel has been performed.

2) Whether a signal/channel is transmitted (whether transmitted or not transmitted) can be indicated through a specific indication.

The receiver receiving this information can determine whether to transmit the corresponding signal/channel according to the instruction.

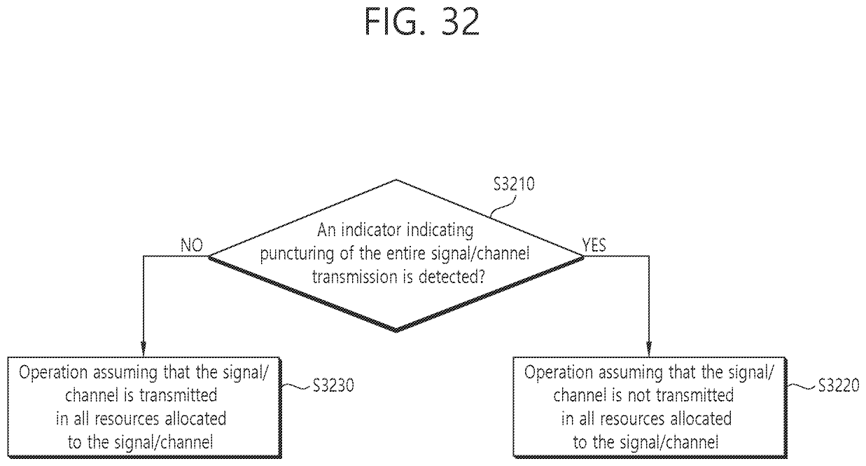

FIG. 32 is an application example of Method 1.

According to FIG. 32, the device may determine whether an indicator indicating puncturing of the entire signal/channel transmission is detected (S3210).

An indicator indicating puncturing for the entire transmission of a signal/channel can be transmitted by an MT of an IAB node or a DU of an IAB node. A channel through which the indicator can be transmitted may vary depending on the transmission entity. This will be described in detail in “B. Transmission method of puncturing resource location information” below.

The device that detects/receives the indicator may operate assuming that the signal/channel is not transmitted in all resources allocated to the signal/channel (S3220). A device that does not detect/receive the indicator may operate assuming that the signal/channel is transmitted in all resources allocated to the signal/channel (S3230).

Method 2. Notifying Whether to Puncture Some OFDM Symbol Resource Regions of a Signal/Channel

The transmitter may inform the receiver of the location of the resource (position of the OFDM symbol) where transmission of a specific signal/channel is not performed (or transmission is performed). The receiver receiving this information can assume that the corresponding signal/channel is not punctured and transmitted at the indicated resource position (OFDM symbol position). More specifically, the following instructions may be used for this purpose.

1) Dividing the OFDM symbol (s) resource through which a specific signal/channel is transmitted into M OFDM symbol groups consisting of consecutive N OFDM symbol (s), information (e.g., index) of OFDM symbol group(s) for which signal/channel transmission has not been performed due to puncturing may be informed. In this case, one OFDM symbol belongs to one OFDM symbol group, and the value of N may be the same or different for each OFDM symbol group.

At this time, the position of the OFDM symbol (s) constituting each OFDM symbol group may be defined in advance and described in the specification. For example, two consecutive OFDM symbols from an OFDM symbol in which transmission of a signal/channel starts can be defined to constitute one OFDM symbol group. In this case, when the number of OFDM symbols through which signal/channel transmission is performed is an odd number, the last OFDM symbol group may consist of one OFDM symbol.

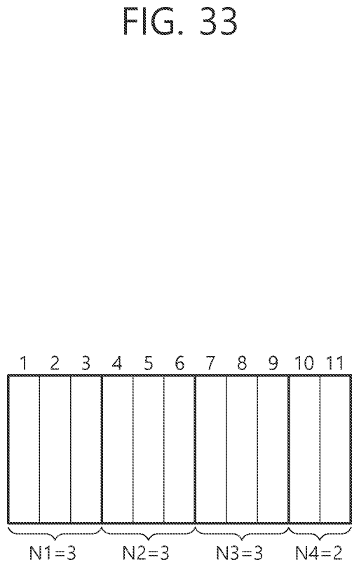

FIG. 33 schematically illustrates an example of an OFDM symbol group.

Alternatively, the value of N, which is the number of OFDM symbol(s) constituting one OFDM symbol group, may be indicated through F1-AP/RRC/MAC CE/DCI. At this time, the number of OFDM symbols (s) constituting the last OFDM symbol group may be less than N. For example, in the example of FIG. 33, a specific channel is transmitted through resources of OFDM symbols #1 to #11, when configured as N=3, three consecutive OFDM symbols from OFDM symbol #1 can constitute one OFDM symbol group. In this case, N1, N2, and N3, which are the numbers of OFDM symbols constituting OFDM symbol groups 1, 2, and 3, are N1=3, N2=3, and N3=3, respectively, N4, which is the number of OFDM symbols constituting OFDM symbol group 4, may be 2.

2) Defining a plurality of candidate OFDM symbol groups in which puncturing can be performed on OFDM symbol (s) resources through which a specific signal/channel is transmitted, among them, information (e.g., index) of an OFDM symbol group in which puncturing is actually performed may be informed. More specifically, M OFDM symbol groups are defined, and one OFDM symbol group may consist of one or a plurality of OFDM symbol(s). In this case, a specific OFDM symbol may be defined to be included in only one OFDM symbol group or included in a plurality of OFDM symbol groups. In this case, the number of OFDM symbols constituting one OFDM symbol group may be different for each OFDM symbol group.

For example, when a specific channel is transmitted through resources of OFDM symbols #1 to #11, OFDM symbol group 1 is composed of OFDM symbols #5, #6, #10, and #11, when OFDM symbol group 2 consists of OFDM symbols #8, #9, #10, and #11, by notifying the index of the 1 or 2 OFDM symbol group, the location of a resource that has not been performed because channel transmission is punctured can be informed. In this case, when OFDM symbol group #2 is indicated, it means that channel transmission is punctured in OFDM symbols #8, #9, #10, and #11.

At this time, the location of the OFDM symbols constituting the OFDM symbol group may also include OFDM symbol resources in which the corresponding signal/channel is not actually transmitted. A specific channel is transmitted through resources of OFDM symbols #1 to #11, when the OFDM symbol resources constituting the OFDM symbol group in which puncturing is performed are #5, #6, #11, and #12, the receiver may determine that channel transmission is not performed and punctured in OFDM symbols #5, #6, and #11.

At this time, information on OFDM symbol(s) constituting each OFDM symbol group may be determined as follows.

a) May be defined in the specification.

b) It can be configured through signaling such as F1-AP/RRC/MAC CE.

3) Defining a plurality of candidate OFDM symbol groups in which puncturing can be performed on OFDM symbol (s) resources through which a specific signal/channel is transmitted, among them, information (e.g., index) of an OFDM symbol group in which puncturing is actually performed may be informed. In this case, a method of configuring each OFDM symbol group may be a hybrid method of method 1) and method 2). That is, some OFDM symbol groups among a plurality of OFDM symbol groups are composed of all or consecutive OFDM symbol (s), in some OFDM symbol groups, resources of constituting OFDM symbols may be configured through signaling such as F1-AP/RRC/MAC CE. For example, candidate OFDM symbol groups may be composed of all or part of OFDM symbol groups configured as follows.
OFDM symbol group consisting of all OFDM symbol resources through which a specific signal/channel is transmitted
M OFDM symbol groups consisting of N OFDM symbol (s) contiguous OFDM symbol (s) resources through which a specific signal/channel is transmitted
M′ OFDM symbol groups in which OFDM symbol (s) information constituting the OFDM symbol group is configured through signaling such as F1-AP/RRC/MAC CE

Method 3. Indicates Whether to Puncture Some Code Blocks Transmitted Through the Data Channel

In the case of a data channel such as PDSCH/PUSCH, the transmitter may inform the receiver of code block information (e.g., index) that has not been transmitted (or has been transmitted) when transmitting the corresponding channel. At this time, the number of code blocks not transmitted (or transmitted) may be plural. The receiver receiving this information may assume that the indicated code block (s) was not punctured and transmitted during transmission of the corresponding data channel.

B. Transmission Method of Puncturing Resource Location Information

In this section, when the transmitter notifies the receiver of the puncturing information for the signal/channel transmitted by the transmitter, a method of transmitting/transferring the corresponding information to the actual receiver is proposed. In this case, the puncturing information for the transmitted signal/channel that the transmitter informs the receiver may be the same as the content proposed in section A above.

B-1. In Case IAB-Node DU Transmits Signal/Channel

If the transmitter of the signal/channel is the IAB-node DU and the receiver is the child IAB-node MT, the puncturing information for the signal/channel can be reported as follows. At this time, these signals/channels may be, for example, PDSCH and CSI-RS.

Method 1. Transmission Through PDCCH

The IAB-node DU may inform the child IAB-node MT of puncturing information about the signal/channel transmitted by itself as in the above section A through the PDCCH (DCI). More specifically, the following methods can be used.

1) Through a PDCCH that can be transmitted periodically, puncturing information on transmission of a signal/channel transmitted during a certain time period can be informed. For example, through a PDCCH that can be transmitted periodically, puncturing information for a PDSCH transmitted during a certain time period can be informed. In this case, the periodically transmitted PDCCH may have a form identical to or similar to DCI format 2_0. If multiple signals/channels are transmitted during a certain period of time, information that can distinguish a signal/channel indicating puncturing information is transmitted together, or the puncturing information for the most recently transmitted signal/channel may be informed.

2) After the punctured signal/channel is transmitted, puncturing information on the transmission of the previous signal/channel may be informed through DCI for scheduling the next signal/channel to be transmitted. For example, puncturing information for a previous PDSCH transmission may be informed through a PDCCH scheduling the retransmitted PDSCH. Alternatively, puncturing information for a previously transmitted (periodic or aperiodic) CSI-RS may be informed through a PDCCH scheduling the aperiodic CSI-RS. In case of indicating puncturing information for a previously transmitted periodic CSI-RS through a PDCCH scheduling an aperiodic CSI-RS, it may indicate puncturing information about the most recently transmitted periodic CSI-RS before the corresponding PDCCH is transmitted.

B-2. When IAB-Node MT Transmits Signal/Channel

If the transmitter of the signal/channel is the IAB-node MT and the receiver is the parent IAB-node DU, puncturing information for the signal/channel can be reported as follows. At this time, these signals/channels may be, for example, PUSCH, (periodic and/or aperiodic) SRS. Characteristically, puncturing information can be informed using different methods in the case of PUSCH and SRS. For example, in the case of SRS, puncturing information may be informed using Method 1 below, and in the case of PUSCH, puncturing information may be informed using Method 2 below.

Method 1. Transmission Through PUCCH

The IAB-node MT may inform the parent IAB-node DU of puncturing information about the signal/channel transmitted by itself as in the above section A through PUCCH. At this time, the name of the channel through which the corresponding information is transmitted may have a name other than PUCCH. The puncturing information for the signal/channel transmitted by the IAB-node MT is transmitted through periodically configured PUCCH transmittable resources, or it may be transmitted together with PUCCH transmitted to transmit other information such as HARQ A/N. SR, and CQI. After the punctured signal/channel is transmitted, puncturing information on transmission of the previous signal/channel may be informed through a PUCCH transmitted next. When puncturing information for a signal/channel transmitted by an IAB-node MT is received through a specific PUCCH, the corresponding information may mean puncturing information on the most recently transmitted signal/channel before PUCCH is transmitted.

Method 2. Transmission Through PUSCH

The IAB-node MT may inform the parent IAB-node DU of puncturing information about the signal/channel transmitted by itself as in the above section A through PUSCH. After the punctured signal/channel is transmitted, puncturing information on transmission of the previous signal/channel may be informed through DCI for scheduling the next signal/channel to be transmitted. For example, puncturing information for a previous PUSCH transmission may be included in the retransmitted PUSCH and transmitted. In this case, the puncturing information may be transmitted through some RE resources among PUSCH transmission resources. In this case, the PUSCH may be rate-matched (or punctured) in the RE resource through which the puncturing information is transmitted and transmitted through the remaining resources. Some of the PUSCH transmission resources in which such puncturing information is transmitted may be transmitted through all or some RE resources of the first k (e.g., k=1) OFDM symbols of the PUSCH transmission resource. This is to receive the puncturing information for the previous PUSCH transmission before the retransmitted PUSCH so that it can be used for decoding the PUSCH.

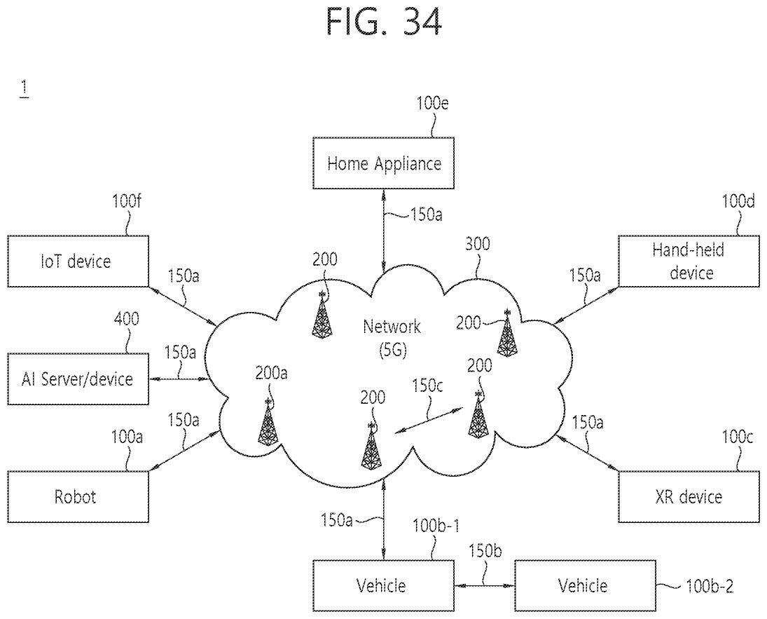

FIG. 34 shows an exemplary communication system (1), according to an embodiment of the present specification.

Referring to FIG. 34, a communication system (1) to which various embodiments of the present specification are applied includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot (100a), vehicles (100b-1, 100b-2), an eXtended Reality (XR) device (100c), a hand-held device (100d), a home appliance (100e), an Internet of Things (IoT) device (100f), and an Artificial Intelligence (AI) device/server (400). For example, the vehicles may include a vehicle having a wireless communication function, an autonomous vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, and so on. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device (200a) may operate as a BS/network node with respect to other wireless devices.

The wireless devices (100a˜100f) may be connected to the network (300) via the BSs (200). An Artificial Intelligence (AI) technology may be applied to the wireless devices (100a˜100f) and the wireless devices (100a˜100f) may be connected to the AI server (400) via the network (300). The network (300) may be configured using a 3G network, a 4G (e.g., LTE) network, or a 5G (e.g., NR) network. Although the wireless devices (100a˜100f) may communicate with each other through the BSs (200)/network (300), the wireless devices (100a˜100f) may perform direct communication (e.g., sidelink communication) with each other without passing through the BSs/network. For example, the vehicles (100b-1, 100b-2) may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices (100a˜100f).

Wireless communication/connections (150a, 150b, 150c) may be established between the wireless devices (100a˜100f)/BS (200), or BS (200)/BS (200). Herein, the wireless communication/connections may be established through various RATs (e.g., 5G NR) such as uplink/downlink communication (150a), sidelink communication (150b)(or D2D communication), or inter BS communication (150c) (e.g., relay, Integrated Access Backhaul (IAB)). The wireless devices and the BSs/the wireless devices may transmit/receive radio signals to/from each other through the wireless communication/connections (150a, 150b, 150c). For example, the wireless communication/connections (150a, 150b, 150c) may transmit/receive signals through various physical channels. For this, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present specification.

Meanwhile, in NR, multiple numerologies (or subcarrier spacing (SCS)) for supporting various 5G services may be supported. For example, in case an SCS is 15 kHz, a wide area of the conventional cellular bands may be supported, and, in case an SCS is 30 kHz/60 kHz dense-urban, lower latency, and wider carrier bandwidth may be supported. In case the SCS is 60 kHz or higher, a bandwidth that is greater than 24.25 GHz may be used in order to overcome phase noise.

An NR frequency band may be defined as two different types of frequency ranges (FR1, FR2). The values of the frequency ranges may be changed (or varied), and, for example, the two different types of frequency ranges (FR1, FR2) may be as shown below in Table 4. Among the frequency ranges that are used in an NR system, FR1 may mean a “sub 6 GHz range”, and FR2 may mean an “above 6 GHz range” and may also be referred to as a millimeter wave (mmW).

TABLE 4

| Frequency Range | Corresponding | Subcarrier |
|---|---|---|
| designation | frequency range | Spacing |
| FR1 | 450 MHz-6000 MHz | 15, 30, 60 kHz |
| FR2 | 24250 MHz-52600 MHz | 60, 120, 240 kHz |

As described above, the values of the frequency ranges in the NR system may be changed (or varied). For example, as shown below in Table 5, FR1 may include a band within a range of 410 MHz to 7125 MHz. More specifically, FR1 may include a frequency band of 6 GHz (or 5850, 5900, 5925 MHz, and so on) and higher. For example, a frequency band of 6 GHz (or 5850, 5900, 5925 MHz, and so on) and higher being included in FR1 may include an unlicensed band. The unlicensed band may be used for various purposes, e.g., the unlicensed band for vehicle-specific communication (e.g., automated driving).

TABLE 5

| Frequency Range | Corresponding | Subcarrier |
|---|---|---|
| designation | frequency range | Spacing |
| FR1 | 410 MHz-7125 MHz | 15, 30, 60 kHz |
| FR2 | 24250 MHz-52600 MHz | 60, 120, 240 kHz |

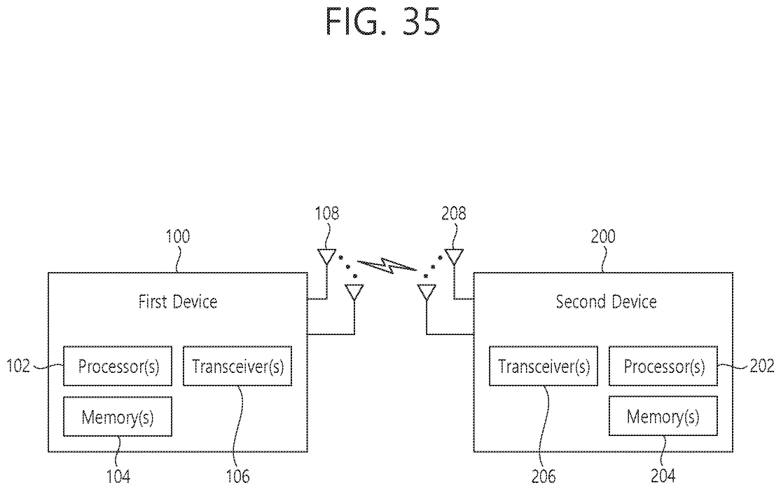

Hereinafter, an example of wireless devices to which the present specification is applied will be described in detail. FIG. 35 shows an exemplary wireless device to which the present specification can be applied.

Referring to FIG. 35, a first wireless device (100) and a second wireless device (200) may transmit radio signals through a variety of RATs (e.g., LTE, NR). Herein, {the first wireless device (100) and the second wireless device (200)} may correspond to {the wireless device (100x) and the BS (200)} and/or {the wireless device (100x) and the wireless device (100x)} of FIG. 34.

The first wireless device (100) may include one or more processors (102) and one or more memories (104) and additionally further include one or more transceivers (106) and/or one or more antennas (108). The processor(s) (102) may control the memory(s) (104) and/or the transceiver(s) (106) and may be configured to implement the descriptions, functions, procedures, proposals, methods, and/or operational flowcharts disclosed in this document. For example, the processor(s) (102) may process information within the memory(s) (104) to generate first information/signals and then transmit radio signals including the first information/signals through the transceiver(s) (106). The processor(s) (102) may receive radio signals including second information/signals through the transceiver (106) and then store information obtained by processing the second information/signals in the memory(s) (104). The memory(s) (104) may be connected to the processor(s) (102) and may store various information related to operations of the processor(s) (102). For example, the memory(s) (104) may store software code including instructions for performing apart or the entirety of processes controlled by the processor(s)(102) or for performing the descriptions, functions, procedures, proposals, methods, and/or operational flowcharts disclosed in this document. Herein, the processor(s) (102) and the memory(s) (104) may be a part of a communication modem/circuit/chip designed to implement RAT (e.g., LTE or NR). The transceiver(s) (106) may be connected to the processor(s) (102) and transmit and/or receive radio signals through one or more antennas (108). Each of the transceiver(s) (106) may include a transmitter and/or a receiver. The transceiver(s) (106) may be interchangeably used with Radio Frequency (RF) unit(s). In the present specification, the wireless device may represent a communication modem/circuit/chip.

The second wireless device (200) may include one or more processors (202) and one or more memories (204) and additionally further include one or more transceivers (206) and/or one or more antennas (208). The processor(s) (202) may control the memory(s) (204) and/or the transceiver(s) (206) and may be configured to implement the descriptions, functions, procedures, proposals, methods, and/or operational flowcharts disclosed in this document. For example, the processor(s) (202) may process information within the memory(s) (204) to generate third information/signals and then transmit radio signals including the third information/signals through the transceiver(s) (206). The processor(s) (202) may receive radio signals including fourth information/signals through the transceiver(s) (206) and then store information obtained by processing the fourth information/signals in the memory(s) (204). The memory(s) (204) may be connected to the processor(s) (202) and may store various information related to operations of the processor(s) (202). For example, the memory(s) (204) may store software code including instructions for performing a part or the entirety of processes controlled by the processor(s) (202) or for performing the descriptions, functions, procedures, proposals, methods, and/or operational flowcharts disclosed in this document. Herein, the processor(s) (202) and the memory(s) (204) may be a part of a communication modem/circuit/chip designed to implement RAT (e.g., LTE or NR). The transceiver(s) (206) may be connected to the processor(s) (202) and transmit and/or receive radio signals through one or more antennas (208). Each of the transceiver(s) (206) may include a transmitter and/or a receiver. The transceiver(s) (206) may be interchangeably used with RF transceiver(s). In the present specification, the wireless device may represent a communication modem/circuit/chip.

Hereinafter, hardware elements of the wireless devices (100, 200) will be described in more detail. One or more protocol layers may be implemented by, without being limited to, one or more processors (102, 202). For example, the one or more processors (102, 202) may implement one or more layers (e.g., functional layers such as PHY, MAC, RLC, PDCP, RRC, and SDAP). The one or more processors (102, 202) may generate one or more Protocol Data Units (PDUs) and/or one or more Service Data Unit (SDUs) according to the descriptions, functions, procedures, proposals, methods, and/or operational flowcharts disclosed in this document. The one or more processors (102, 202) may generate messages, control information, data, or information according to the descriptions, functions, procedures, proposals, methods, and/or operational flowcharts disclosed in this document. The one or more processors (102, 202) may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers (106, 206). The one or more processors (102, 202) may receive the signals (e.g., baseband signals) from the one or more transceivers (106, 206) and obtain the PDUs, SDUs, messages, control information, data, or information according to the descriptions, functions, procedures, proposals, methods, and/or operational flowcharts disclosed in this document.

The one or more processors (102, 202) may be referred to as controllers, microcontrollers, microprocessors, or microcomputers. The one or more processors (102, 202) may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors (102, 202). The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors (102, 202) or stored in the one or more memories (104, 204) so as to be driven by the one or more processors (102, 202). The descriptions, functions, procedures, proposals, methods, and/or operational flowcharts disclosed in this document may be implemented using firmware or software in the form of code, instructions, and/or a set of instructions.

The one or more memories (104, 204) may be connected to the one or more processors (102, 202) and store various types of data, signals, messages, information, programs, code, instructions, and/or commands. The one or more memories (104, 204) may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories (104, 204) may be located at the interior and/or exterior of the one or more processors (102, 202). The one or more memories (104, 204) may be connected to the one or more processors (102, 202) through various technologies such as wired or wireless connection.

The one or more transceivers (106, 206) may transmit user data, control information, and/or radio signals/channels, mentioned in the methods and/or operational flowcharts of this document, to one or more other devices. The one or more transceivers (106, 206) may receive user data, control information, and/or radio signals/channels, mentioned in the descriptions, functions, procedures, proposals, methods, and/or operational flowcharts disclosed in this document, from one or more other devices. For example, the one or more transceivers (106, 206) may be connected to the one or more processors (102, 202) and transmit and receive radio signals. For example, the one or more processors (102, 202) may perform control so that the one or more transceivers (106, 206) may transmit user data, control information, or radio signals to one or more other devices. The one or more processors (102, 202) may perform control so that the one or more transceivers (106, 206) may receive user data, control information, or radio signals from one or more other devices. The one or more transceivers (106, 206) may be connected to the one or more antennas (108, 208) and the one or more transceivers (106, 206) may be configured to transmit and receive user data, control information, and/or radio signals/channels, mentioned in the descriptions, functions, procedures, proposals, methods, and/or operational flowcharts disclosed in this document, through the one or more antennas (108, 208). In this document, the one or more antennas may be a plurality of physical antennas or a plurality of logical antennas (e.g., antenna ports). The one or more transceivers (106, 206) may convert received radio signals/channels, and so on, from RF band signals into baseband signals in order to process received user data, control information, radio signals/channels, and so on, using the one or more processors (102, 202). The one or more transceivers (106, 206) may convert the user data, control information, radio signals/channels, and so on, processed using the one or more processors (102, 202) from the base band signals into the RF band signals. For this, the one or more transceivers (106, 206) may include (analog) oscillators and/or filters.

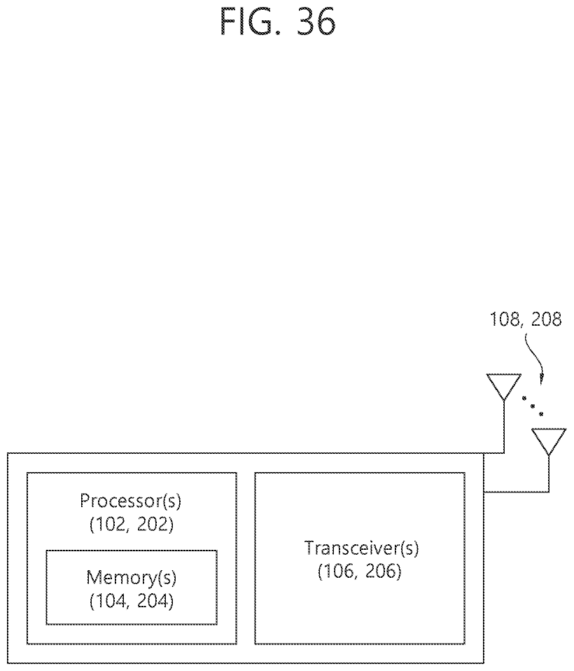

FIG. 36 shows another example of a wireless device applicable to the present specification.

According to FIG. 36, the wireless device may include at least one processor (102, 202), at least one memory (104, 204), at least one transceiver (106, 206), and/or one or more antennas (108, 208).

As a difference between the example of the wireless device described above in FIG. 35 and the example of the wireless device in FIG. 36, in FIG. 35, the processors 102 and 202 and the memories 104 and 204 are separated, but in the example of FIG. 36, the memories 104 and 204 are included in the processors 102 and 202.

Here, a detailed description of the processors 102 and 202, the memories 104 and 204, the transceivers 106 and 206, and the one or more antennas 108 and 208 is as described above, in order to avoid unnecessary repetition of description, description of repeated description will be omitted.

Hereinafter, an example of a signal processing circuit to which the present specification is applied will be described in detail.

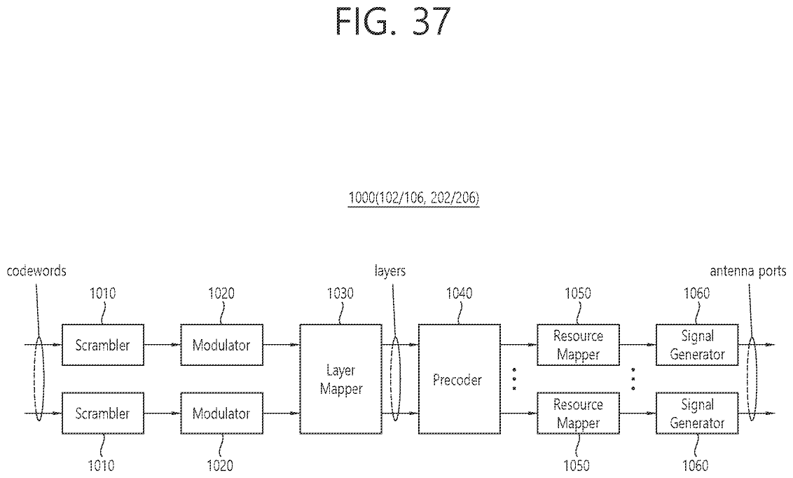

FIG. 37 shows a signal process circuit for a transmission signal according to an embodiment of the present specification.

Referring to FIG. 37, a signal processing circuit (1000) may include scramblers (1010), modulators (1020), a layer mapper (1030), a precoder (1040), resource mappers (1050), and signal generators (1060). An operation/function of FIG. 37 may be performed, without being limited to, the processors (102, 202) and/or the transceivers (106, 206) of FIG. 35. Hardware elements of FIG. 37 may be implemented by the processors (102, 202) and/or the transceivers (106, 206) of FIG. 35. For example, blocks 1010˜1060 may be implemented by the processors (102, 202) of FIG. 35. Alternatively, the blocks 1010˜1050 may be implemented by the processors (102, 202) of FIG. 35 and the block 1060 may be implemented by the transceivers (106, 206) of FIG. 35.

Codewords may be converted into radio signals via the signal processing circuit (1000) of FIG. 37. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH).

More specifically, the codewords may be converted into scrambled bit sequences by the scramblers (1010). Scramble sequences used for scrambling may be generated based on an initialization value, and the initialization value may include ID information of a wireless device. The scrambled bit sequences may be modulated to modulation symbol sequences by the modulators (1020). A modulation scheme may include pi/2-Binary Phase Shift Keying (pi/2-BPSK), m-Phase Shift Keying (m-PSK), and m-Quadrature Amplitude Modulation (m-QAM). Complex modulation symbol sequences may be mapped to one or more transport layers by the layer mapper (1030). Modulation symbols of each transport layer may be mapped (precoded) to corresponding antenna port(s) by the precoder (1040). Outputs z of the precoder (1040) may be obtained by multiplying outputs y of the layer mapper (1030) by an N*M precoding matrix W Herein, N is the number of antenna ports, and M is the number of transport layers. The precoder (1040) may perform precoding after performing transform precoding (e.g., DFT) for complex modulation symbols. Additionally, the precoder (1040) may perform precoding without performing transform precoding.

The resource mappers (1050) may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators (1060) may generate radio signals from the mapped modulation symbols and the generated radio signals may be transmitted to other devices through each antenna. For this purpose, the signal generators (1060) may include Inverse Fast Fourier Transform (IFFT) modules, Cyclic Prefix (CP) inserters, Digital-to-Analog Converters (DACs), frequency uplink converters, and so on.

Signal processing procedures for a signal received in the wireless device may be configured in a reverse manner of the signal processing procedures (1010˜1060) of FIG. 37. For example, the wireless devices (e.g., 100, 200 of FIG. 35) may receive radio signals from the exterior through the antenna ports/transceivers. The received radio signals may be converted into baseband signals through signal restorers. For this, the signal restorers may include frequency downlink converters, Analog-to-Digital Converters (ADCs), CP remover, and Fast Fourier Transform (FFT) modules. Subsequently, the baseband signals may be restored to codewords through a resource demapping procedure, a postcoding procedure, a demodulation processor, and a descrambling procedure. The codewords may be restored to original information blocks through decoding. Therefore, a signal processing circuit (not shown) for a reception signal may include signal restorers, resource demappers, a postcoder, demodulators, descramblers, and decoders.

Hereinafter, a usage example of the wireless to which the present specification is applied will be described in detail.

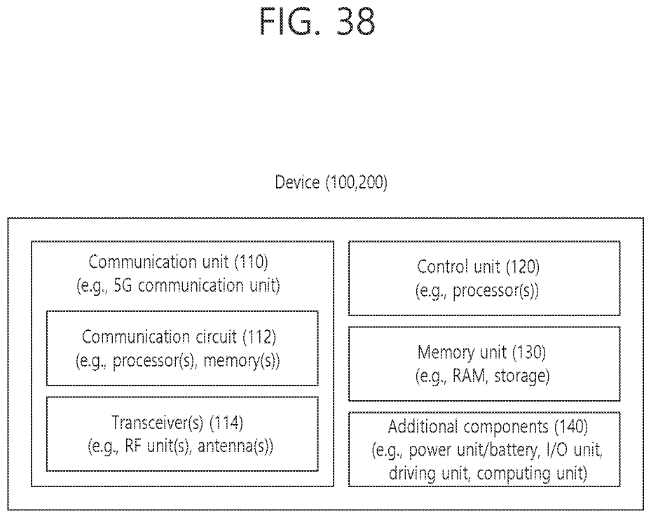

FIG. 38 shows another example of a wireless device according to an embodiment of the present specification. The wireless device may be implemented in various forms according to a use-case/service (refer to FIG. 34).

Referring to FIG. 38, wireless devices (100, 200) may correspond to the wireless devices (100, 200) of FIG. 35 and may be configured by various elements, components, units/portions, and/or modules. For example, each of the wireless devices (100, 200) may include a communication unit (110), a control unit (120), a memory unit (130), and additional components (140). The communication unit may include a communication circuit (112) and transceiver(s) (114). For example, the communication circuit (112) may include the one or more processors (102, 202) and/or the one or more memories (104, 204) of FIG. 35. For example, the transceiver(s) (114) may include the one or more transceivers (106, 206) and/or the one or more antennas (108, 208) of FIG. 35. The control unit (120) is electrically connected to the communication unit (110), the memory (130), and the additional components (140) and controls overall operation of the wireless devices. For example, the control unit (120) may control an electric/mechanical operation of the wireless device based on programs/code/instructions/information stored in the memory unit (130). The control unit (120) may transmit the information stored in the memory unit (130) to the exterior (e.g., other communication devices) via the communication unit (110) through a wireless/wired interface or store, in the memory unit (130), information received through the wireless/wired interface from the exterior (e.g., other communication devices) via the communication unit (110).

The additional components (140) may be variously configured according to types of wireless devices. For example, the additional components (140) may include at least one of a power unit/battery, input/output (I/O) unit, a driving unit, and a computing unit. The wireless device may be implemented in the form of, without being limited to, the robot (100a of FIG. 34), the vehicles (100b-1, 100b-2 of FIG. 34), the XR device (100c of FIG. 34), the hand-held device (100d of FIG. 34), the home appliance (100e of FIG. 34), the IoT device (100f of FIG. 34), a digital broadcast terminal, a hologram device, a public safety device, an MTC device, a medicine device, a fintech device (or a finance device), a security device, a climate/environment device, the AI server/device (400 of FIG. 34), the BSs (200 of FIG. 34), a network node, and so on. The wireless device may be used in a mobile or fixed place according to a usage-example/service.

In FIG. 38, the entirety of the various elements, components, units/portions, and/or modules in the wireless devices (100, 200) may be connected to each other through a wired interface or at least a part thereof may be wirelessly connected through the communication unit (110). For example, in each of the wireless devices (100, 200), the control unit (120) and the communication unit (110) may be connected by wire and the control unit (120) and first units (e.g., 130, 140) may be wirelessly connected through the communication unit (110). Each element, component, unit/portion, and/or module within the wireless devices (100, 200) may further include one or more elements. For example, the control unit (120) may be configured by a set of one or more processors. As an example, the control unit (120) may be configured by a set of a communication control processor, an application processor, an Electronic Control Unit (ECU), a graphical processing unit, and a memory control processor. As another example, the memory (130) may be configured by a Random Access Memory (RAM), a Dynamic RAM (DRAM), a Read Only Memory (ROM)), a flash memory, a volatile memory, a non-volatile memory, and/or a combination thereof.

Hereinafter, an example of implementing FIG. 38 will be described in detail with reference to the drawings.

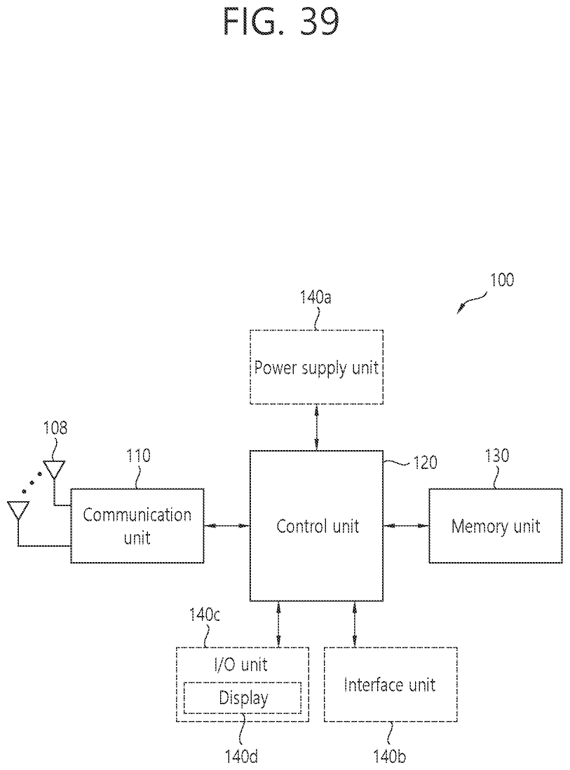

FIG. 39 shows a hand-held device to which the present specification is applied. The hand-held device may include a smartphone, a smartpad, a wearable device (e.g., a smartwatch or a smartglasses), or a portable computer (e.g., a notebook). The hand-held device may be referred to as a mobile station (MS), a user terminal (UT), a Mobile Subscriber Station (MSS), a Subscriber Station (SS), an Advanced Mobile Station (AMS), or a Wireless Terminal (WT).

Referring to FIG. 39, a hand-held device (100) may include an antenna unit (108), a communication unit (110), a control unit (120), a memory unit (130), a power supply unit (140a), an interface unit (140b), and an I/O unit (140c). The antenna unit (108) may be configured as a part of the communication unit (110). Blocks 110˜130/140a˜140c correspond to the blocks 110˜130/140 of FIG. 38, respectively.

The communication unit (110) may transmit and receive signals (e.g., data and control signals) to and from other wireless devices or BSs. The control unit (120) may perform various operations by controlling constituent elements of the hand-held device (100). The control unit (120) may include an Application Processor (AP). The memory unit (130) may store data/parameters/programs/code/instructions (or commands) needed to drive the hand-held device (100). The memory unit (130) may store input/output data/information. The power supply unit (140a) may supply power to the hand-held device (100) and include a wired/wireless charging circuit, a battery, and so on. The interface unit (140b) may support connection of the hand-held device (100) to other external devices. The interface unit (140b) may include various ports (e.g., an audio I/O port and a video I/O port) for connection with external devices. The I/O unit (140c) may input or output video information/signals, audio information/signals, data, and/or information input by a user. The U/O unit (140c) may include a camera, a microphone, a user input unit, a display unit (140d), a speaker, and/or a haptic module.

As an example, in the case of data communication, the I/O unit (140c) may obtain information/signals (e.g., touch, text, voice, images, or video) input by a user and the obtained information/signals may be stored in the memory unit (130). The communication unit (110) may convert the information/signals stored in the memory into radio signals and transmit the converted radio signals to other wireless devices directly or to a BS. The communication unit (110) may receive radio signals from other wireless devices or the BS and then restore the received radio signals into original information/signals. The restored information/signals may be stored in the memory unit (130) and may be output as various types (e.g., text, voice, images, video, or haptic) through the I/O unit (140c).

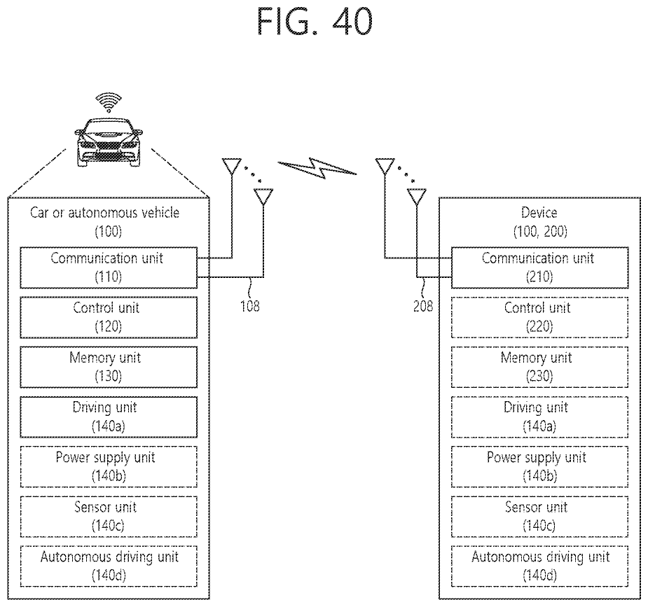

FIG. 40 shows a vehicle or an autonomous vehicle to which the present specification is applied. The vehicle or autonomous vehicle may be implemented by a mobile robot, a car, a train, a manned/unmanned Aerial Vehicle (AV), a ship, and so on.

Referring to FIG. 40, a vehicle or autonomous vehicle (100) may include an antenna unit (108), a communication unit (110), a control unit (120), a driving unit (140a), a power supply unit (140b), a sensor unit (140c), and an autonomous driving unit (140d). The antenna unit (108) may be configured as a part of the communication unit (110). The blocks 110/130/140a˜140d correspond to the blocks 110/130/140 of FIG. 38, respectively.

The communication unit (110) may transmit and receive signals (e.g., data and control signals) to and from external devices such as other vehicles, BSs (e.g., gNBs and road side units), and servers. The control unit (120) may perform various operations by controlling elements of the vehicle or the autonomous vehicle (100). The control unit (120) may include an Electronic Control Unit (ECU). The driving unit (140a) may cause the vehicle or the autonomous vehicle (100) to drive on a road. The driving unit (140a) may include an engine, a motor, a powertrain, a wheel, a brake, a steering device, and so on. The power supply unit (140b) may supply power to the vehicle or the autonomous vehicle (100) and include a wired/wireless charging circuit, a battery, and so on. The sensor unit (140c) may obtain a vehicle state, ambient environment information, user information, and so on. The sensor unit (140c) may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, and so on. The autonomous driving unit (140d) may implement technology for maintaining a lane on which a vehicle is driving, technology for automatically adjusting speed, such as adaptive cruise control, technology for autonomously driving along a determined path, technology for driving by automatically setting a path if a destination is set, and so on.

For example, the communication unit (110) may receive map data, traffic information data, and so on, from an external server. The autonomous driving unit (140d) may generate an autonomous driving path and a driving plan from the obtained data. The control unit (120) may control the driving unit (140a) such that the vehicle or the autonomous vehicle (100) may move along the autonomous driving path according to the driving plan (e.g., speed/direction control). In the middle of autonomous driving, the communication unit (110) may aperiodically/periodically obtain recent traffic information data from the external server and obtain surrounding traffic information data from neighboring vehicles. In the middle of autonomous driving, the sensor unit (140c) may obtain a vehicle state and/or surrounding environment information. The autonomous driving unit (140d) may update the autonomous driving path and the driving plan based on the newly obtained data/information. The communication unit (110) may transfer information on a vehicle position, the autonomous driving path, and/or the driving plan to the external server. The external server may predict traffic information data using AI technology, and so on, based on the information collected from vehicles or autonomous vehicles and provide the predicted traffic information data to the vehicles or the autonomous vehicles.

Claims in the present specification may be combined in various ways. For instance, technical features in method claims of the present specification may be combined to be implemented or performed in an apparatus (or device), and technical features in apparatus claims may be combined to be implemented or performed in a method. Further, technical features in method claim(s) and apparatus claim(s) may be combined to be implemented or performed in an apparatus. Further, technical features in method claim(s) and apparatus claim(s) may be combined to be implemented or performed in a method.

1. A method for performing mobile terminal (MT) operation and distributed unit (DU) operation in a wireless communication system, the method performed by an integrated access and backhaul (IAB) node and comprising:
performing an initial access operation with a parent node and a child node, respectively;
performing the MT operation with the parent node; and
performing the DU operation with the child node,
wherein a first demodulation reference signal (DMRS) is applied to the MT operation, and a second DMRS is applied to the DU operation, and
wherein each of the first DMRS and the second DMRS is respectively applied with a DMRS port belonging to a different code division multiplexing (CDM) group.

2. The method of claim 1, wherein the MT operation is operation related to communication between the IAB node and the child node,
wherein the DU operation is operation related to communication between the IAB node and the parent node.

3. The method of claim 1, wherein the child node is another IAB node or a user equipment (UE).

4. The method of claim 1, wherein the IAB node receives information for a CDM group of the second DMRS for the DU operation.

5. The method of claim 4, wherein the information for the CDM group is configured from a centralized unit (CU) or a donor node through a radio resource control (RRC) or a F1 application protocol (F1-AP).

6. The method of claim 4, wherein the information for the CDM group is configured from the parent node through a medium access control (MAC) or downlink control information (DCI).

7. The method of claim 4, wherein the IAB node selects a DMRS port in a DMRS port index having a CDM group value included in the information for the CDM group,
wherein the IAB node performs the DU operation based on the selected DMRS port.

8. The method of claim 7, wherein the IAB node assumes that a DMRS port for the MT operation is determined among DMRS ports using a CDM group other than at least one CDM group available for the DU operation.

9. An Integrated Access and Backhaul (IAB) node that performs a mobile terminal (MT) operation and a distributed unit (DU) operation, comprising
a transceiver;
at least one memory; and
at least one processor operably coupled with the at least one memory and the transceiver, the at least one processor configured to:
perform an initial access operation with a parent node and a child node, respectively;
perform the MT operation with the parent node; and
perform the DU operation with the child node,
wherein a first demodulation reference signal (DMRS) is applied to the MT operation, and a second DMRS is applied to the DU operation, and
wherein each of the first DMRS and the second DMRS is respectively applied with a DMRS port belonging to a different code division multiplexing (CDM) group.

10. An apparatus comprising
at least one memory; and
at least one processor operably coupled with the at least one memory, the at least one processor configured to:
perform an initial access operation with a parent node and a child node, respectively;
perform mobile terminal (MT) operation with the parent node; and
perform distributed unit (DU) operation with the child node,
wherein a first demodulation reference signal (DMRS) is applied to the MT operation, and a second DMRS is applied to the DU operation, and
wherein each of the first DMRS and the second DMRS is respectively applied with a DMRS port belonging to a different code division multiplexing (CDM) group.

11-13. (canceled)
